(19) United States
(12) Patent Application Publication
(10) Pub. No.: US 2025/0065442 A1
(43) Pub. Date: Feb. 27, 2025

(54) AUTOMATED PROCESS FOR FORMING FEATURES ON OPHTHALMIC LENS

(71) Applicant: SIGHTGLASS VISION, INC., Dallas, TX (US)

(72) Inventor: Peter Hones, Dallas, TX (US)

(21) Appl. No.: 18/720,320

(22) PCT Filed: Dec. 15, 2022
(86) PCT No.: PCT/US2022/053013

§ 371 Date: Jun. 14, 2024

Related U.S. Application Data
(60) Provisional application No. 63/290,021, filed on Dec. 15, 2021.

(51) Int. Cl. B23K 26/352; B23K 26/03; B23K 26/08; B23K 26/382; B23K 101/00

(52) U.S. Cl. CPC B23K 26/352; B23K 26/032; B23K 26/083; B23K 26/382; B23K 2101/00

(57) ABSTRACT

Ophthalmic lenses and method of manufacturing ophthalmic lenses that include automated steps are disclosed.

### BACKGROUND

The eye is an optical sensor in which light from external sources is focused, by a lens, onto the surface of the retina, an array of wavelength-dependent photosensors. The lens of the eye can accommodate by changing shape such that the focal length at which external light rays are optimally or near-optimally focused to produce inverted images on the surface of the retina that correspond to external images observed by the eye. The eye lens focuses light, optimally or near-optimally, emitted by, or reflected from external objects that lie within a certain range of distances from the eye, and less optimally focuses, or fails to focus objects that lie outside that range of distances.

In normal-sighted individuals, the axial length of the eye, or distance from the front of the cornea to the fovea of the retina, corresponds to a focal length for near-optimal focusing of distant objects. The eyes of normal-sighted individuals focus distant objects without nervous input to muscles which apply forces to alter the shape of the eye lens, a process referred to as “accommodation.” Closer, nearby objects are focused, by normal individuals, as a result of accommodation.

Many people, however, suffer from eye-length-related disorders, such as myopia (“nearsightedness”). In myopic individuals, the axial length of the eye is longer than the axial length required to focus distant objects without accommodation. As a result, myopic individuals can view near objects at a certain distance clearly, but objects further away from that distance are blurry.

Typically, infants are born hyperopic, with eye lengths shorter than needed for optimal or near-optimal focusing of distant objects without accommodation. During normal development of the eye, referred to as “emmetropization,” the axial length of the eye, relative to other dimensions of the eye, increases up to a length that provides near-optimal focusing of distant objects without accommodation. Ideally, biological processes maintain the near-optimal relative eye length to eye size (e.g., axial length) as the eye grows to final, adult size. However, in myopic individuals, the relative axial length of the eye to overall eye size continues to increase during development, past a length that provides near-optimal focusing of distant objects, leading to increasingly pronounced myopia.

It is believed that myopia is affected by environmental factors as well as genetic factors. Accordingly, myopia may be mitigated by therapeutic devices which address environmental factors. For example, therapeutic devices for treating eye-length related disorders, including myopia, are described in U.S. Pub. No. 2011/0313058A1.

Therapeutic devices for reducing myopic progression include certain ophthalmic lenses, such as certain eyeglass lenses and certain contact lenses. Prescription eyeglasses and contact lenses are commonly dispensed through eye care professional offices or via online dispensaries. In each case, particularly for eyeglasses, these devices are customized specifically for each patient. For example, a patient can select a pair of eyeglasses from a substantial range of styles and brands. For a given prescription, they can also select from a variety of different stock lenses with a variety of different possible coatings (e.g., hardcoats and optical filters, such as short-wavelength filters, and/or photochromic filters). Multi-focal lenses are also possible, which involve an even higher degree of customization. In each case, the eyeglasses are provided to their end user in a timely fashion by virtue of a supply chain than enables Just-In-Time manufacturing the eyeglasses. Lens manufacturers generally supply stock lenses to regional supply centers that can customize the lenses to, e.g., shape one or both lens surfaces, apply coatings to one or both of the lens surfaces, and shape what are usually circular blanks to fit specific eyeglass frames selected by the user. In some cases, stock lenses are supplied from the manufacturer with one or more coatings already applied.

Certain ophthalmic lens technologies for reducing progression of myopia utilize a lens that can have a base curvature suitable for correcting any refractive error for the wearer and a pattern of optical elements on a surface of the lens that deviate from the base curvature. For example, Diffusion Optical Technology (DOT) lens technology from SightGlass Vision, Inc. features patterns of optical elements.

In many instances, these patterns should carefully aligned with an axis of the lens. For example, certain DOT spectacle lens products from SightGlass Vision, Inc. feature an aperture free of the optical features that can be aligned with an axis of the lens corresponding, e.g., to the visual axis of the eye for distance vision.

### SUMMARY

Techniques for automating the formation of optical elements in a pattern on a surface of an ophthalmic lens are disclosed. In particular, optical alignment techniques are used to align an ophthalmic lens relative to a laser system, which then exposes the ophthalmic lens to laser radiation to form the optical elements on the surface and/or in the bulk of the ophthalmic lens in a pattern that is accurately aligned with respect to the lens, e.g., with respect the lens axis or lens perimeter.

In general, in a first aspect, the disclosure features a method for forming a pattern of optical features on a surface of an ophthalmic lens having a lens axis, including: receiving the ophthalmic lens on a stage; positioning the ophthalmic lens relative to a first apparatus by causing relative motion between the first apparatus and the stage; measuring light transmitted or reflected by the ophthalmic lens or a surface property of the ophthalmic lens using the first apparatus; determining a position of the lens axis based on the measured light or surface property; obtaining information about an alignment of the pattern of optical features relative to the lens axis; aligning the ophthalmic lens with a laser system based on the position of the lens axis; and exposing locations of the ophthalmic lens to a laser beam from the laser system to form the pattern of optical features on the ophthalmic lens according to the information about the alignment.

Implementations of the method can include one or more of the following features. For example, the first apparatus can be a light sensing apparatus and the position of the lens axis is determined based on the measured light. In some cases, the first apparatus is a surface profiler and the position of the lens axis is determined based on the surface property.

The laser beam can form the optical features on a surface of the ophthalmic lens. The laser beam can form the optical features in a bulk of the ophthalmic lens.

Determining the position of the lens can include determining a position of a lens axis of the lens. The position of the lens axis can be determined based on an image of the ophthalmic lens obtained from the measured light. Alternatively, or additionally, the position of the lens axis can be determined based on a surface profile of the ophthalmic lens obtained from the measured light. In some examples, the position of the lens axis is determined based on a prism measurement of the ophthalmic lens obtained from the measurement light.

The lens axis can coincide with a geometric center of the ophthalmic lens.

The lens axis can correspond to an optical axis of the ophthalmic lens.

The optical elements can include light scattering centers. The optical elements can include microlenses (lenslets) and/or prismatic elements.

The ophthalmic lens can be a single vision lens or a multifocal lens (e.g., a bifocal lens or a progressive lens).

The ophthalmic lens can continuously move relative to the light sensing apparatus while measuring the light transmitted or reflected by the lens.

The ophthalmic lens can continuously move relative to the laser system while exposing the locations of the ophthalmic lens.

The method can include automatically changing a relative position of the ophthalmic lens with respect to the light sensing apparatus and the laser system after measuring the light transmitted or reflected by the ophthalmic lens. The light sensing apparatus and the laser system can be stationary while the ophthalmic lens is moved. The ophthalmic lens can be stationary while the light sensing apparatus and the laser system are moved.

The method of any one of the preceding claims, wherein the pattern comprises an aperture free of the optical elements.

The aperture can be surrounded by a region containing optical elements.

In some examples, the lens axis intersects the aperture.

The aperture can have a maximum lateral dimension of 2 mm or more.

Exposing the locations of the ophthalmic lens to the laser beam can include varying a position of a surface of the ophthalmic lens with respect to a focal plane of the laser system. Varying the position of the surface can include changing a distance between the stage and the laser system.

The method can include determining an exposure sequence for the laser system for forming the pattern of optical features on the ophthalmic lens based on the information about the alignment. Determining the exposure sequence can include geometrically transforming (e.g., rotating and/or translating in one or more dimensions) a predetermined pattern based on the information about the alignment to account for the position of the lens axis.

Among other advantages, the techniques disclosed herein can improve throughput of manufacturing of myopia control lenses by automating alignment of the lens relative to a laser system to accurately form a pattern of optical elements on the ophthalmic lens.

### BRIEF DESCRIPTION OF THE DRAWINGS

FIG. 1 is a schematic diagram of an example of an automated alignment and exposure system.

FIG. 2 is a flow chart showing steps in the operation of the automated alignment and exposure system shown in FIG. 1.

FIG. 3A is a plan view of an ophthalmic lens on an example platform prior to formation of optical elements.

FIG. 3B is a plan view of the ophthalmic lens shown in FIG. 3A after formation of optical elements.

FIGS. 3C-3D are plan view diagrams showing examples of radially symmetric ophthalmic lenses with radially symmetric patterns.

FIGS. 3E-3H are plan view diagrams showing are examples of radially asymmetric ophthalmic lenses with radially symmetric patterns.

FIGS. 3I-3L are plan view diagrams showing examples of ophthalmic lenses radially symmetric lenses with radially asymmetric patterns.

FIGS. 3M-3V are plan view diagrams showing examples of ophthalmic lenses

FIG. 4 is a plan view diagram of an example ophthalmic lens with a pattern of optical elements that includes two clear apertures.

FIG. 5 shows a pair of spectacles containing ophthalmic lenses as shown in FIG. 4.

FIG. 6A and 6B are diagrams illustrating horizontal and vertical fields of view, respectively, for a person.

FIGS. 7A-7D illustrate steps in a process of manufacturing process an example ophthalmic lens featuring optical elements and a marker for specifying orientation of the lens.

FIGS. 8A-8D illustrate steps in a process of manufacturing process an example ophthalmic lens featuring optical elements an edge feature for specifying orientation of the lens.

FIGS. 9A-9C illustrate steps in a process of manufacturing process an example ophthalmic lens featuring optical elements on both surfaces.

FIG. 10 is a plan view diagram of an example ophthalmic lens with a pattern of optical elements that includes two clear apertures.

FIG. 11 is a plan view diagram of another example ophthalmic lens with a pattern of optical elements that includes two clear apertures.

FIG. 12 is a plan view diagram of a further example ophthalmic lens with a pattern of optical elements that includes two clear apertures.

FIG. 13 is a plan view diagram of an example ophthalmic lens with a pattern of optical elements that includes no clear apertures.

FIG. 14 is a schematic diagram of another example of an automated alignment and exposure system.

FIG. 15 is a schematic diagram showing examples of an electronic controller useful in automated alignment and exposure systems.

In the drawings, like reference numerals indicate like elements.

### DETAILED DESCRIPTION

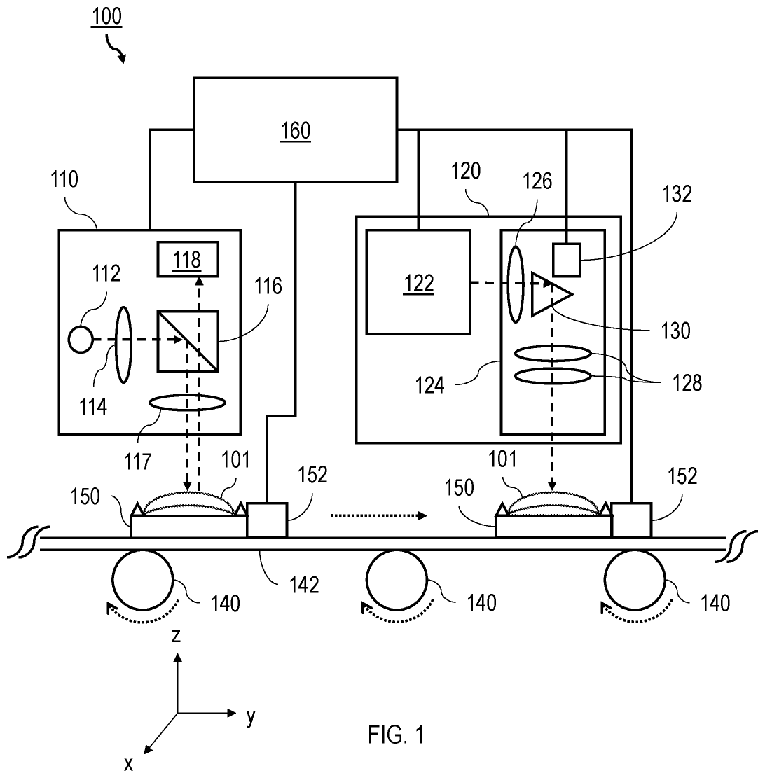

Referring to FIG. 1, an example automated alignment and exposure system 100 for forming patterns of optical elements on a surface and/or in the bulk material of a stock ophthalmic lens 101 includes a measurement subsystem 110, a laser exposure subsystem 120, and a conveyor that transports the lens 101 between the two subsystems. Operation of the subsystems and conveyor is controlled by an electronic controller 160. Generally, electronic controller 160 can include one or more computer systems (e.g., including electronic processors, memory, and interfaces facilitating operation by a controller). A Cartesian coordinate system is provided for ease of reference.

The conveyor includes a conveyor belt 140 with rollers 142 and stages 150 positioned on the conveyor belt 140 that each support a corresponding lens 101 and position the lens 101 with respect to the measurement subsystem 110 and laser exposure subsystem 120. The conveyor belt 140 moves the stages 150 in the y-direction, advancing the stage first beneath the measurement subsystem 110 and then to the laser exposure subsystem 120. Each stage includes an actuator 152 that moves the corresponding stage 150 in the x-direction, orthogonal to the direction of travel of the conveyor belt 140.

Measurement subsystem 110 performs an optical measurement of lens 101 when lens 101 passes beneath it and determines a position of a lens axis of lens 101 with respect to the system. The system then moves the lens 101 to laser exposure subsystem 120 where the lens is exposure to a laser beam to form a pattern of optical elements on and/or in the lens 101. The system forms the pattern according to the position of the lens axis determined via the optical measurement to ensure that the pattern is accurately located on the lens.

As shown in FIG. 1, optical measurement subsystem 110 includes a light source 112, light shaping optics 114, a beam splitter 116, focusing optics 117, and an image sensor 118. During operation, the subsystem 110 directs illumination from light source 112 to illuminate lens 101, and directs the light reflected from lens 101 to sensor 118. Light shaping optics 114 are arranged and configured to shape light emitted from the light source to sufficiently illuminate a field of view of the subsystem 110. Beam splitter 116 directs light from the light shaping optics 114 towards the stage 150 and focusing optics 117 both direct the light to the stage and receive light reflected from the lens 101, forming an image of the lens 101 on the sensor 118. Generally, light shaping optics 114 and 117 can include one or more optical elements (e.g., lenses, diffusers, polarizers, wavelength filters) and these elements can be distributed at various locations along the optical path of the light (e.g., upstream or downstream from the beam splitter 116 for both illumination light and received light). Electronic controller 160 both controls the operation of the measurement subsystem 110 and receives data from sensor 118 for analysis.

Laser exposure subsystem 120 includes a laser source 122 and a beam steering assembly that receives a laser beam from the laser source 122 and focuses and directs the laser beam onto lens 101 as the lens moves through an exposure field of the subsystem 120. The beam steering assembly 124 includes collimating optics 126 and focusing optics 128. A reflector 130 is arranged between the collimating optics 126 and the focusing optics 128. The reflector 130 is coupled to the reflector 130 and configured to scan the location of the focused laser beam across lens 101 (e.g., along one or two axes). In some implementations, reflector 130 is a galvo mirror assembly.

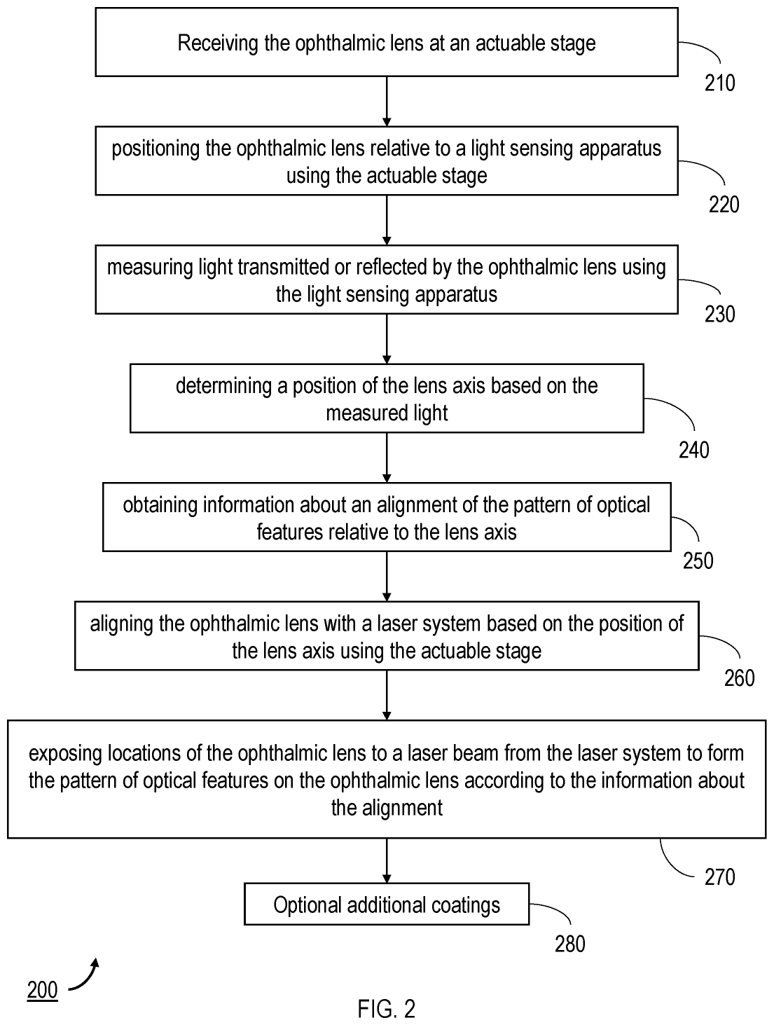

Referring to FIG. 2, system 100 can be used to form a pattern of optical features on a surface of an ophthalmic lens using a sequence of steps shown in flowchart 200. In an initial step 210, the ophthalmic lens 101 is received by the system on stage 150. The lens 101 can be manually placed on the stage or loaded on the stage in another automated process, e.g., using a robot placement arm.

Next, in step 220, the system positions the lens 101 relative to measurement subsystem 110 by moving the stage 150 relative to the subsystem. Once positioned appropriately, in step 230, measurement subsystem 110 performs a measurement by directing light to the lens 101 and measuring light reflected therefrom. In the present implementation, the lens 101 continuously moves relative to measurement subsystem 110 while the subsystem detects the light reflected by the lens. However, in some implementations, the system can maintain the lens stationary relative to the measurement subsystem while the measurement is made. Note also that while measurement subsystem 110 operates using light reflected from the ophthalmic lens, in some examples a measurement can be made based on transmitted light.

In step 240, the system determines a position of the axis of the lens 101 based on the measured light. In general, a variety of suitable optical measurement techniques can be used to locate the lens axis of lens 101. For example, in some implementations, the measurement subsystem 110 is a machine vision system and the position of the lens axis is determined based on an image of the ophthalmic lens obtained from the measured light. Where the ophthalmic lens is a round lens, for instance, the lens perimeter can be identified from the image and the position of the lens axis determined as the position of the geometric center of the circular perimeter.

In some examples, the measurement subsystem 110 determines an orientation of the lens by measuring a prism of the lens 101. For example the subsystem 110 can measure the lateral displacement of a beam reflected from the top surface of the lens from the beam reflected from the bottom surface of the lens. In certain cases, the stage 150 can adjust the orientation of the lens 101 to reduce (e.g., minimize) the amount of displacement of these beams. The lens axis can correspond to the location and orientation with zero prism.

In certain implementations, the measurement subsystem 110 can profile a surface of the lens 101 and the position of the lens axis is determined based on the surface profile. For example, the measurement subsystem 110 can be an imaging interferometer that measures a wavefront reflected from the entire lens surface simultaneously using imaging optics and a camera sensor.

In some examples, measurement subsystem 110 makes non-optical measurements of the lens 101 in order to determine the position of the lens axis. For example, the subsystem can measure a property (e.g., a profile) of a lens surface through mechanical or electromagnetic contact sensing. Examples of such include systems that use a stylus, a caliper, or a feeler. In some cases, the subsystem can make one or more surface profile measurements (e.g., along different sections of the lens) from which the position of the lens axis can be determined. Two, three, four, or more different measurements can be made. In some cases, the subsystem can iteratively make profile measurements along different directions until the lens axis location is determined to a preset confidence level.

The axis of lens 101 can corresponds to an optical axis of the ophthalmic lens. For example, the axis can be an axis of rotational symmetry of the lens surface or surfaces. In certain implementations, the lens axis coincides with a geometric center of the lens 101. For instance, the lens axis can correspond to a central axis of a circular lens. In certain cases, the central axis is co-axial with the optical axis of a lens.

In step 250, the system obtains information about an alignment of the pattern of optical features relative to the lens axis. This can be accomplished based on information supplied from an eye care professional or other third party and/or can be based on patterns that the system operator has (e.g., located in memory in the electronic controller of the system). The pattern generally includes information about the location of each optical element relative to the lens axis and/or relative to some other fiducial with which the system can faithfully arrange the optical elements on the lens. For example, the pattern can include information about the location of a single optical element with respect to the lens axis, but then includes information about the location of every other optical element relative to at least one other optical element.

In step 260, the system aligns the ophthalmic lens 101 relative to laser exposure subsystem 120 based on the position of the lens axis. This involves conveying the ophthalmic lens 101 on stage 150 from the measurement subsystem 110 to the laser exposure subsystem 120 and positioning the lens 101 appropriately for exposure to beam steering assembly 124. Once appropriately positioned, in step 270, the system exposes discrete locations of the ophthalmic lens 101 to the laser beam from the laser exposure subsystem 120 to form the pattern of optical features on the ophthalmic lens according to the information about the alignment.

The process of aligning the pattern with the lens can include mathematical transformations of the pattern in software in order to account for the relative orientation and placement of the lens in the system. Such transformations can include displacements (e.g., in one, two, or three dimensions) and/or rotations (e.g., about one or more axes) of a pre-existing pattern to change the pattern from a coordinate system in which the pattern information is supplied and a coordinate system of the lens on the stage. The system determines an exposure sequence of for the laser exposure subsystem to expose the lens based on the aligned pattern to ensure accurate alignment of the pattern relative to the lens axis.

Alternatively, the system can calculate a pattern on the fly based on the placement of the lens and/or one or more additional factors (e.g., based on the surface curvature of the lens, the optical power of the lens).

Generally, the optical elements can be formed on a surface of the lens and/or in the bulk material of the lens. Generally, the type of laser used in subsystem 120 can vary depending on the nature of the lens 101 (e.g., the lens composition) and the optical elements being formed thereon.

Depending on the implementation, the system can move the ophthalmic lens 101 continuously relative to the laser exposure subsystem 120 while exposing the locations of the ophthalmic lens. Alternatively, the system can hold the lens stationary during exposure or incrementally step the lens along the y-direction during the exposure.

In some implementations, the entire measurement and exposure process is automatic and continuous, in which the system automatically conveys the ophthalmic lens from the measurement subsystem to the laser exposure subsystem after measuring the light transmitted or reflected by the ophthalmic lens and then exposing the lens to form the pattern while continuously moving the lens along the conveyor.

In some examples, the system adjusts the position of the lens along the z-direction to maintain the lens surface at or close to the focal point of the laser beam. For example, the system can maintain a surface of the lens within 1 mm of the position of best focus of the beam. The system can adjust the position of the lens along the z-direction to change the spot size of the laser beam on the lens surface. Generally, the spot size at the lens surface will increase the further the lens surface is from the focal plane. The system can change the z-position of the lens during the exposure to account for the curvature of the lens surface. For example, the system can decrease the distance between the lens surface and the laser exposure subsystem as a function of increasing radial distance from the lens axis.

In general, the system can move the lens to the appropriate position relative to the laser exposure subsystem for the pattern based on the measurement, the system can adjust the pattern (e.g., by rotating and/or translating the pattern), or can adjust both the lens and the pattern.

The system can also adjust the speed of relative motion between the laser beam and the lens depending on one or more parameters. For example, the exposure can be sped up if the surface close to the focal plane of the laser (i.e., where the energy density of the beam is relatively high) compared to when the surface is further from the focal plane.

The process outlined in FIG. 2 can include additional steps. For example, additional coatings can be applied to one or both of the lens surfaces either before or after application of pattern 155 (step 280). Examples include UV or blue light filters, anti-reflective coatings, photochromic coatings, polarizers, mirror coatings, tints, and hardcoats. In some cases, additional shaping of a lens surface is performed, e.g., to customize a multifocal lens to the user either before or after application of pattern 155.

The additional coatings can be applied by a processing station downstream from the laser exposure subsystem of system 100, or can be applied separately from the system.

It is believed that automated and/or continuous manufacturing methods can enable large scale manufacturing of ophthalmic lenses with patterns of optical elements in an economic manner. The disclosed systems and methods can provide accurate alignment of the patterns to the lens axis (or other lens feature). For example, the systems can align the patterns so that they have a maximum displacement of 1 mm or better (e.g., 0.8 mm or better, 0.5 mm or better, 0).3 mm or better, 0.2 mm or better, 0.1 mm or better) from a target location on the lens. It is believed that for lenses with a base curvature of, e.g., +4D or more, placement accuracy of 1 mm or better is desirable to reduce strong prismatic effects.

This process can be carried out at an optical store, distribution center, optical lab, or centralized manufacturing facility. Because the lens modification can be performed locally on lenses from a lens inventory, and in coordination with existing eyeglass dispensing protocols, Just-in-Time delivery of a highly customized pair of eyeglasses that includes a pattern of optical elements, such as a customized pattern of optical elements, is possible.

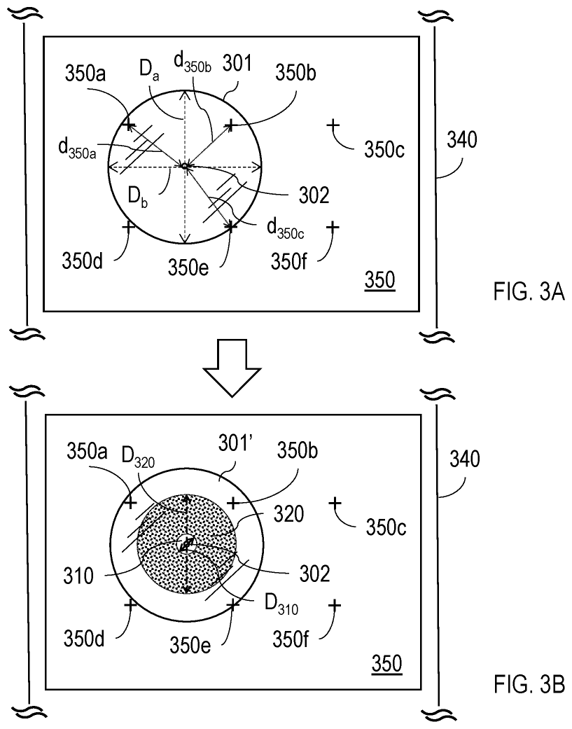

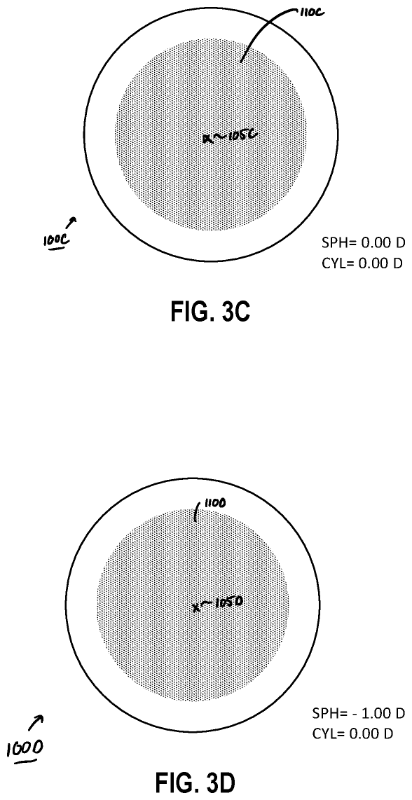

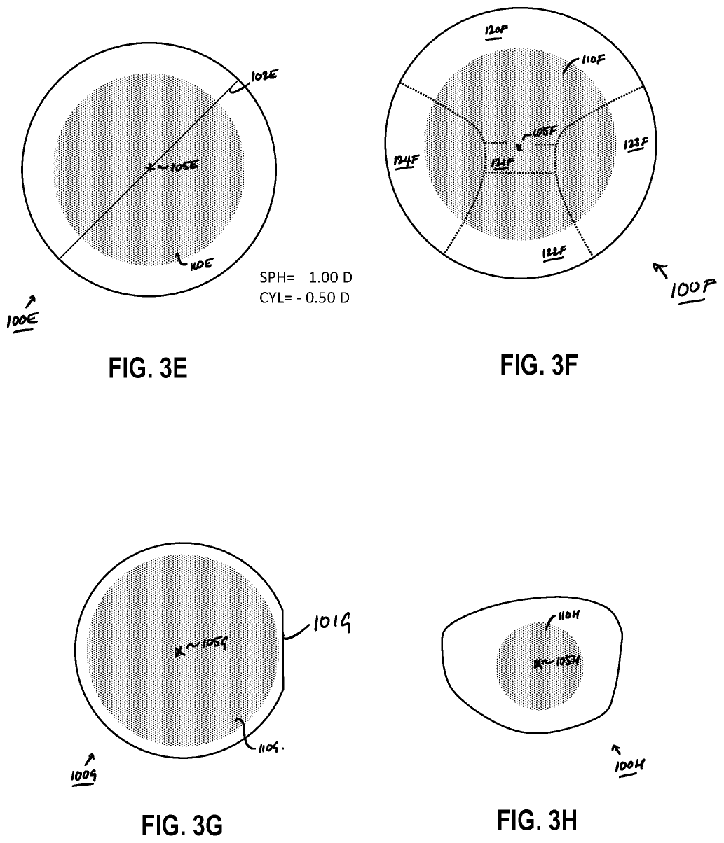

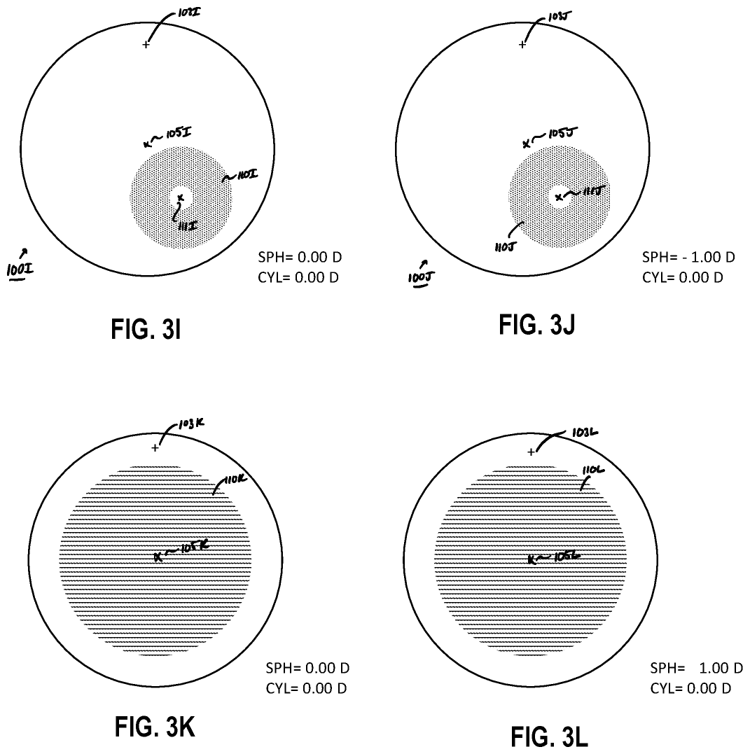

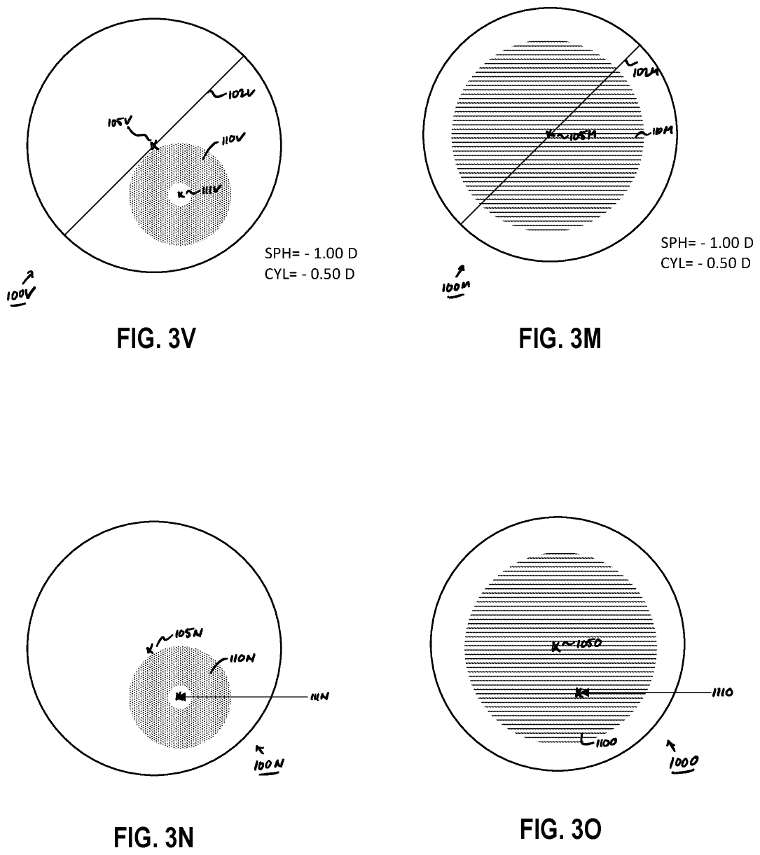

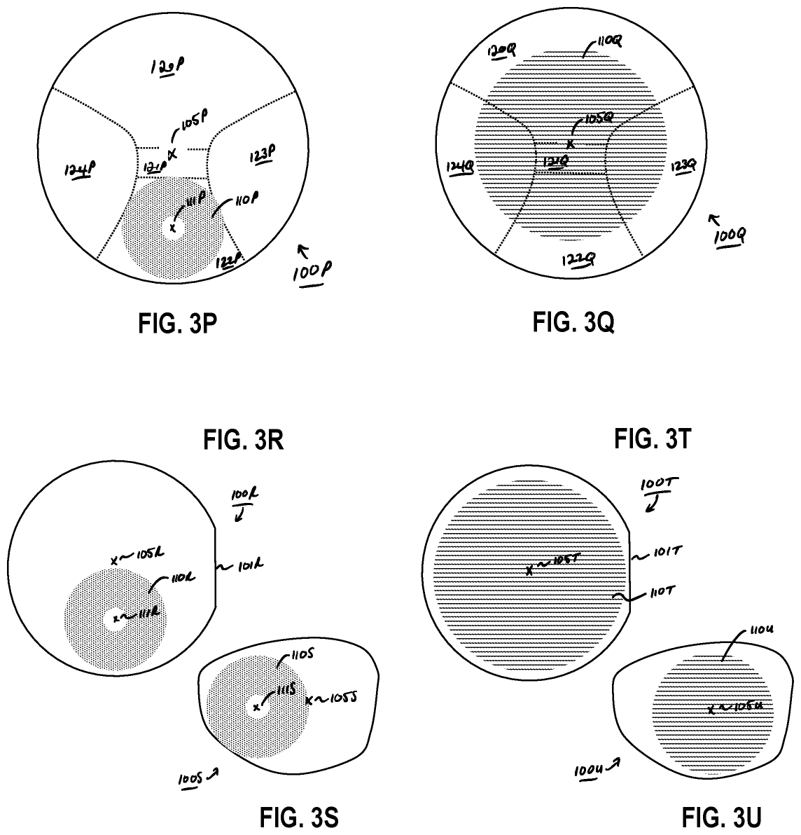

In some implementations, the stage 150) can include one or more fiducial markers and the system can determine the position of the lens axis relative to the position of the one or more fiducial markers in order to facilitate alignment of the lens relative to the laser exposure. Such a system is illustrated, by way of example, in FIGS. 3A and 3B. FIG. 3A shows, in plan view; a lens 301 placed on a stage 350 which is carried by a conveyor belt 340. The surface of stage 350 includes six fiducial markers 350a-350f at various locations across the surface. As illustrated, the lens is positioned so that it covers markers 350a, 350b, and 350e.

The fiducial markers are of a size and shape that they can be reliably identified by the measurement subsystem. For example, the fiducial markers can be applied (e.g., etched, printed) so that they have a high contrast relative to the stage surface at light wavelengths used by the measurement subsystem.

In some examples, the measurement subsystem is a machine vision system that acquires an image of the entire lens and the electronic controller can determine the location of the lens axis relative to each of the fiducial markers in the field of view of the subsystem. For example, the system can determine the location of the axis 302 as the location at which two different (e.g., perpendicular) diameters Da and Db of lens 301 intersect. The system can further determine the location of the fiducial markers 350a, 350b, and 350e relative to the lens axis 302. For example, the location of each of these fiducial markers can be established as (x, y) co-ordinates in a co-ordinate system defined by the two perpendicular diameters Dₐ and D_{b}, in which the lens axis 302 corresponds to the origin.

Referring to FIG. 3B specifically, subsequently, the laser exposure subsystem can establish the location of lens axis 302 by first locating fiducial markers 350a, 350b, and 350d using another alignment module. Based on the location of the lens axis 302, the laser exposure subsystem forms a pattern 320 of optical elements composed of an annular area of optical elements surrounding a clear aperture 310 centered on axis 302.

Of course, the example implementation shown in FIGS. 3A and 3B is merely illustrative. In general, any appropriate arrangement of fiducial markers appropriate for use with the measurement and alignment techniques employed can be used.

In general, the ophthalmic lens can be any ophthalmic lens suitable for use in myopia control eyeglasses. Commercial stock lenses can be used. The ophthalmic lens can be a plano lens, a single vision lens (e.g., with positive or negative spherical optical power and/or cylinder), or a multi focal lens (e.g., a bifocal or progressive lens). In some examples, the ophthalmic lens has a non-zero prism power.

Generally, the lens is a circular lens that is subsequently edged to fit eyeglass frames selected by the wearer. However, the techniques disclosed herein can similarly be applied to non-round lenses (e.g., lenses that are edged for eyeglass frames before formation of the optical element pattern).

The optical elements can include light scattering centers (dots). Alternatively, or additionally, the optical elements can be lenslets. Examples of light scattering centers are described in PCT Publication No. WO2018026697A1, entitled “Ophthalmic lenses for treating myopia,” and in U.S. Publication No. 2019/0235279A1, entitled “Ophthalmic lenses with light scattering for treating myopia,” the entire contents both of which are incorporated herein by reference. Examples of lenslets are described in U.S. Pat. No. 11,029,540B2. entitled “Spectacle lens and method of using a spectacle lens.”

The optical elements can be formed in any appropriate pattern. For purposes of clarity, as used herein, the pattern refers to both the shape of the area in which optical elements are formed and the arrangement of discrete optical elements within those areas. In some examples, as described above, the optical elements can be formed within an annular ring on the lens surface or in the bulk material of the lens, although other arrangements are possible. Examples of patterns of optical elements are described in both PCT Pub. No. WO2018026697A1 and in U.S. Pub. No. 2019/0235279A1. Other examples of possible patterns are described in PCT Pub. No. WO2020/113212, entitled “Light scattering lens for treating myopia and eyeglasses containing the same,” and in PCT. Pub. No. WO2021236687A2, entitled “Ophthalmic lenses, method of manufacturing the ophthalmic lenses, and methods of dispenses eye care products including the same.” The entire contents of both WO2020/113212 and WO2021236687A2 are hereby incorporated by reference in their entirety.

In some examples, both the lens and the pattern are radially symmetric. In other words, the lens and patterns both have symmetry about a central axis. This can also be referred to as rotationally symmetric. For example, a plano lens or a lens having only spherical power, when provided with a circular edge, is a radially symmetric lens. In general, lenses having a circular edge are referred to as circular lenses, even though the curvature of the surfaces extend out of the plane of the circle defined by the edge.

Further, the optical elements can be arranged in a pattern that has radial symmetry about a geometric center of the pattern. Such patterns generally have a circular perimeter and, optically, perform the same function regardless of which radial direction the user looks through. In such cases, a geometric center of the pattern, such as the center of a clear aperture within an annular region of optical elements, can be aligned to the optical center of the lens.

However, more generally, the foregoing techniques can also be used to form rotationally asymmetric patterns on radially symmetric or radially asymmetric lenses. Generally, this involves establishing a relative alignment between the lens and the pattern that accounts for the asymmetries before forming the optical elements. The system adjusts the alignment as necessary so that the relative alignment is as specified. In some examples, structural and/or optical alignment features can be formed on the lens that allow for alignment of the lens within the lens modification system before forming the optical elements. Examples are discussed below which generally fall within the following four categories:

### Type 1: Radially Symmetric Lenses (e.g. with Radially Symmetric Power Profile) and Radially Symmetric Patterns

(i) Circular, plano lens with a radially symmetric pattern centered on the lens. An example of such a lens is shown in FIG. 3C. Lens 100C is a plano lens (SPH=0.00 D, CYL=0.00 D) that includes a radially symmetric pattern 110C of optical elements centered on the geometric center 105C of the lens.
(ii) Circular, spherical-powered lens without cylinder power with a radially symmetric pattern centered on the lens. An example of such a lens is shown in FIG. 3D. Here, lens 100D is a spherical-powered lens (SPH=−1.00 D, CYL=0.00 D) that includes a radially symmetric pattern 110D of optical elements centered on the geometric center 105D of the lens. Geometric center 105D coincides with the optical center of lens 100D.

### Type 2: Radially Asymmetric Lenses (e.g., with a Radially Asymmetric Power Profile) and Radially Symmetric Patterns

(i) Circular, plano or circular, spherical-powered lens with a cylindrical power axis and a radially symmetric pattern centered on the lens. An example of such a lens is shown in FIG. 3E. A lens 100E having SPH=−1.00 D and CYL=−0.50 D along cylinder axis 102E includes a pattern 110E that is radially symmetric centered on the geometric center 105E of the lens. Note that the “cylinder axis” or “cyl axis” is not the same as the lens axis. Rather, the cylinder axis refers to the meridian along which a lens with a non-zero CYL power has no cylinder power. Such lenses are commonly prescribed to correct astigmatism.
(ii) Multi-focal or progressive lens with a radially symmetric pattern centered on the lens. An example of such a lens is shown in FIG. 3F, in which a progressive lens 100F has five zones of differing optical power (120F, 121F, 122F, 123F, and 124F). A radially symmetric pattern 110F is centered at the geometric center 105F of the lens.
(iii) Non-circular lens, such as a lens with flat edge or notch, or a lens that has been shaped to fit eyeglass frames, with a radially symmetric pattern centered on the lens. Examples of such lenses are shown in FIG. 3G and 3H. In FIG. 3G, a lens 100G is circular but for a flat edge 101G. Lens 101G includes a radially symmetric pattern 110G that is centered at the radial center 105G of the circular portion of the edge of the lens. Center 105G may coincide with the optical center of the lens. FIG. 3H shows a lens 100H shaped to fit a pair of eyeglass frames. Lens 100H includes a radially symmetric pattern 110H with a center 105H that may coincide with the optical center of lens 100H.

### Type 3: Radially Symmetric Lenses and Patterns Radially Asymmetric With Respect to Lens

(i) Circular, plano lens with a radially symmetric pattern, with the center of the lens not matching geometric center of the pattern. FIG. 3I shows an example of such a lens. Here, a plano lens 100I includes a pattern 110I that is radially symmetric about a point 111I offset from a geometric center 105I of the lens. A marker 103I (e.g., on or within the lens) can be used as a fiducial when aligning the pattern with the lens.
(ii) Circular, spherical-powered lens without cylinder power with a radially symmetric pattern, with the center of the lens not matching geometric center of the pattern. FIG. 3J shows an example of such a lens. Specifically, a spherical lens 100J includes a pattern 110J that is radially symmetric about a point 111J offset from a geometric center 105J of the lens. The geometric center can coincide with the optical center of the lens. A marker 103J can be used as a fiducial when aligning the pattern with the lens.
(iii) Circular, plano lens with a radially asymmetric pattern. An example of such a lens is shown in FIG. 3K, where a plano lens 100K includes a pattern 110K having a circular outline by formed by horizontal lines of optical elements (e.g., rows of scattering centers or lenslets). The center of the circle of pattern 110K is aligned with the geometric center 105K of the lens. A marker 103K can be used as a fiducial when aligning the pattern with the lens.
(iv) Circular, spherical-powered lens without cylinder power with a radially asymmetric pattern. FIG. 3L shows an example of such a lens. Here, a spherical lens 100L includes a pattern 110L having a circular outline by formed by horizontal lines of optical elements (e.g., rows of scattering centers or lenslets). The center of the circle of pattern 110L is aligned with the geometric center 105L of the lens. The geometric center can coincide with the optical center of the lens. A marker 103L can be used as a fiducial when aligning the pattern with the lens.

### Type 4: Radially Asymmetric Lenses and Patterns Radially Asymmetric With Respect to Lens

(i) Circular plano or spherical-powered lens with a cylindrical power axis and a radially symmetric pattern not centered on the lens. FIG. 3V shows an example of such a lens. Here, a lens 100V with SPH=−1.00 D, CYL=−0.50 D with cylinder axis 102V includes a pattern 110V of optical elements that is radially symmetric about a point 111V offset from a geometric center 105V of the lens.
(ii) Circular plano or spherical-powered lens with a cylindrical power axis and a radially asymmetric pattern. An example of such a lens is shown in FIG. 3M. Here, a lens 100M with SPH=−1.00 D, CYL=−0.50 D with cylinder axis 102M includes a pattern 110M having a circular outline formed by horizontal lines of optical elements (e.g., rows of scattering centers or lenslets). The center of the circle of pattern 110M is aligned with the geometric center 105M of the lens.
(iii) Circular plano or spherical-powered lens, with or without cylindrical power axis, with a de-centered optical center, and a radially symmetric pattern not centered on the lens. FIG. 3N shows an example of such a lens. Here, a lens 100N includes a pattern 110N that is radially symmetric about a point 111N offset from a geometric center 105N of the lens. Point 111N coincides with the optical center of lens 100N.
(iv) Circular plano or spherical-powered lens, with or without cylindrical power axis, with a de-centered optical center, and a radially asymmetric pattern. FIG. 30 shows an example of such a lens. Here, a lens 100O includes a pattern 110O having a circular outline formed by horizontal lines of optical elements (e.g., rows of scattering centers or lenslets). The center of the circle of pattern 110O is aligned with the geometric center 105O of the lens but the optical center 111O of the lens is offset from the geometric center 105O.
(v) Circular multifocal or progressive lens and a radially symmetric pattern not centered on the lens. FIG. 3P shows an example of such a lens. Here, a progressive lens 100P has five zones of differing optical power (120P, 121P, 122P, 123P, and 124P). A radially symmetric pattern 110P is centered at a point 111P that is in zone 122P and offset from the geometric center 105P of the lens which is located in zone 121P.
(vi) Circular multifocal or progressive lens and a radially asymmetric pattern, an example of which is shown in FIG. 3Q. Here, lens 100Q includes a pattern 110Q of optical elements arranged in parallel lines 120Q arranged horizontally across the lens, spanning zones (102Q, 103Q, 104Q, 105Q, and 106Q) of the lens have differing optical power. The radial center of pattern 110Q is aligned with the geometric center 105Q of lens 100Q.
(vii) Non-circular lens (such as a lens with flat edge or notch, or a lens that has been shaped to fit eyeglass frames) with a radially symmetric pattern not centered on the lens. FIG. 3R shows an example of such a lens 100R having a flat edge portion 101R and a pattern 110R of optical elements radially symmetric about a point 111R decentered from an optical center 105R of lens 100R. FIG. 3S shows an example of a lens 100S having an edge shaped to fit eyeglass frames. Lens 100S includes a pattern 110S that is radially symmetric about a point 111S but not centered on the optical center 105S of the lens.
(vii) Non-circular lens (such as a lens with flat edge or notch, or a lens that has been shaped to fit eyeglass frames) with a radially asymmetric pattern. FIG. 3T shows an example of such a lens 100T having a flat edge portion 101T and a pattern 110T of optical elements with a circular outline. Pattern 110T is composed of horizontal rows of optical elements and the circle outlining the optical elements is centered on the optical center 105T of lens 100T. FIG. 3U shows an example of a lens 100U having an edge shaped to fit eyeglass frames. Lens 100U includes a pattern 110U of optical elements with a circular outline. Pattern 110U is composed of horizontal rows of optical elements and the circle outlining the optical elements is centered on the optical center 105U of lens 100U.

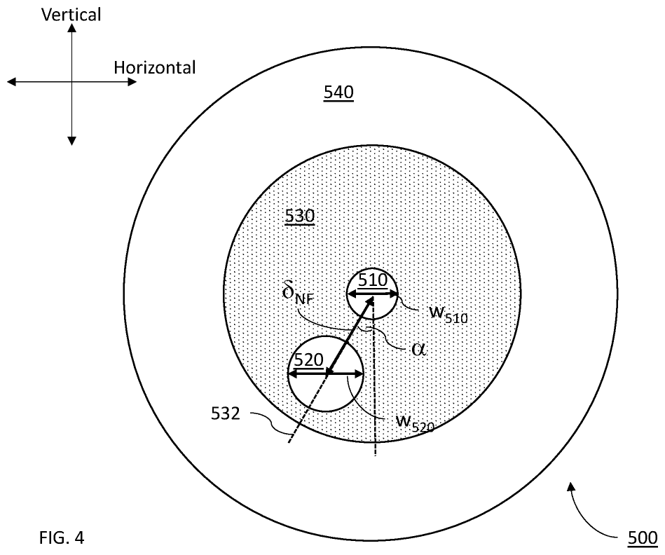

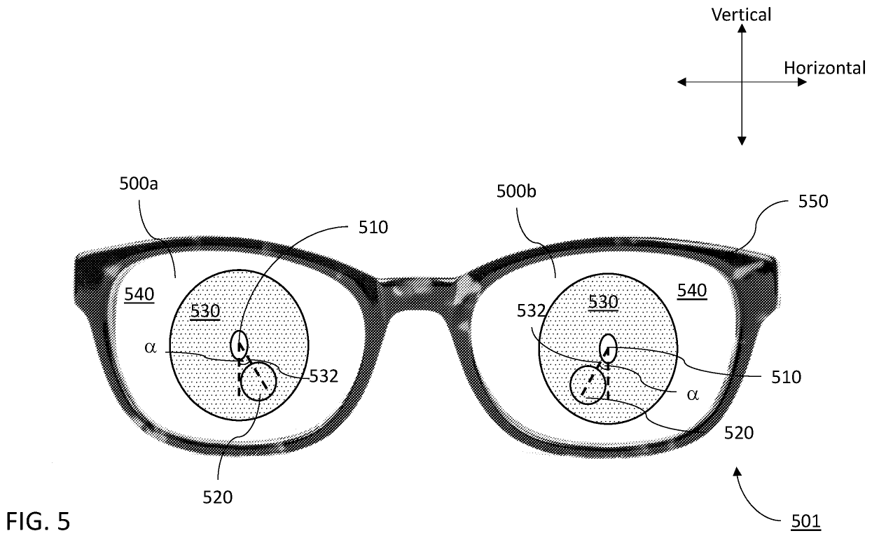

Turning now to further examples of optical element patterns, in general, a variety of different patterns are possible. As noted above, in some examples, rotationally asymmetric patterns are used. Such patterns lack radial symmetry about an axis, such as an axis running through a geometry center of the pattern. An example of such a pattern is illustrated in FIG. 4, which shows an ophthalmic lens 500 includes a first clear aperture 510 and an annular shaped scattering area 530 surrounding the clear aperture. In this case, the lens 500 has uniform optical properties, e.g., is a single vision lens, such as a spherical lens or a compound or toric lens (i.e., having a spherical component and a cylindrical component), or a plano lens (i.e., a lens with no optical power). FIG. 5 also shows a vertical and horizontal axis for ease of reference. While lens 500 is depicted as a circular blank, and therefore radially symmetric for a spherical lens, it will be understood that the horizontal and vertical directions refer to how the lens will be oriented when mounted in glasses frames.

First clear aperture 510 is positioned substantially near the center of lens 500. Patterned area 530 is also centered with respect to the lens center. Patterned area 530 is also surrounded by a clear area 540. A second clear aperture 520 is also provided in patterned area 530, separated from clear aperture 510 along an axis 532 that is offset by an angle a from the vertical axis of the lens.

In the example show in FIG. 4, clear aperture 510 is a distance vision aperture, which can be engaged for distance-vision activities such as reading road signs. The second clear aperture 520 is a near vision aperture, which can be engaged for near-vision activities, such as reading a book.

When α refers to the offset angle from the vertical meridian once mounted, it can be selected to accommodate the path of the user's eye when they focus on near objects. When a person accommodates to focus on near objects, this also creates convergence, or the movement of the eyes inward in the horizontal direction, called vergence. Therefore, in order to make near-vision objects visible to the accommodated eye through the second aperture, the angle can be chosen to match a user's vergence for near objects. In some examples, α is 45° or less, e.g., about 30° or less, about 25° or less, about 20° or less, about 15° or less, about 10° or less, about 8° or less, e.g., 1° or more, 2° or more, 3° or more, 4° or more, 5° or more, or 0°. For example, the clear aperture 520—for near-vision—can be offset from the vertical axis that passes through the center of clear aperture 510 toward the user's nose in order to accommodate for vergence of the wearer's eyes as they focus on near objects. This offset can be 1 mm or more (e.g., 2 mm or more, 3 mm or more, 4 mm or more, 5 mm or more, 6 mm or more, 7 mm or more, such as 10 mm or less, 9 mm or less, 8 mm or less), where the distance is measured from the central point in the horizontal direction of clear aperture 520 from the central point in the horizontal direction of clear aperture 510 (which may correspond to the center of the lens, in some examples). Both clear aperture 510 and clear aperture 520 are circular in shape, with aperture 520 having a slightly larger diameter than aperture 510. Generally, the size of the apertures can vary and are set so that they provide the user with adequate on-axis vision (through aperture 510) and adequate near-vision (through aperture 520) while not being so large as to significantly impede the effect of the contrast reduction in peripheral vision due to the optical elements in the patterned area. Typically, both clear apertures have diameters of 2 mm or more (e.g., 3 mm or more, 4 mm or more, 5 mm or more, such as 10 mm or less).

Non-circular apertures are also possible (see below for specific examples). For instance, the horizontal width of an aperture can be different from a vertical height of the apertures. In FIG. 4, the horizontal widths of apertures 510 and 520 are designated w₅₁₀ and w₅₂₀, respectively. Generally, the horizontal widths of the apertures can be the same or different. In some examples, such as illustrated in FIG. 4, w₅₂₀ can be larger than w₅₁₀. For example, w₅₂₀ can be 10% or more larger than w₅₁₀ (e.g., 20% or more, 30% or more, 40% or more, 50% or more, 75% or more, 100% or more, such as 200% or less, 150% or less, 120% or less). In some examples, the w₅₂₀ is selected so that, for near vision, the user's visual axis stays within the clear aperture 520 while the user is engaged with a specific task during which their eye horizontally scans a visual field (e.g., while reading). This can be advantageous where it allows the user to scan the visual field through the clear aperture without having to move their head.

The distance between the apertures can also vary and is typically set so that the apertures correspond to comfortable on-axis vision and comfortable near-vision for the user. The distance between the closest edges of the clear apertures can be 1 mm or more (e.g., 2 mm or more, 5 mm or more, such as 10 mm or less).

A distance between the centers of aperture 510 and aperture 520, denoted δ_{NF} in FIG. 4, can vary so that aperture 520 corresponds to gaze direction of the user when focused on near objects. In some examples, δ_{NF} can be in a range from 0.5 mm to 20 mm (e.g., 0.6 mm or more, 0.7 mm or more, 0.8 mm or more, 0.9 mm or more, 10 mm or more, 11 mm or more, 12 mm or more, 13 mm or more, 14 mm or more, e.g., 19 mm or less, 18 mm or less, 17 mm or less, 16 mm or less, 15 mm or less).

The separation between aperture 510 and aperture 520 depends on the size of each aperture and the distance between their centers. In some examples, this separation can be 0.5 mm or more (e.g., 1 mm or more, 2 mm or more, 3 mm or more). The separation can be less than 10 mm (e.g., 9 mm or less, 8 mm or less, 7 mm or less, 6 mm or less, 5 mm or less).

Patterned area 530) includes optical elements which scatter at least some of the light incident on the lens in these areas or which defocus or blur through optical aberrations. This can reduce contrast of the peripheral vision of a user, which is believed to reduce development of myopia in a user. Generally, optical elements can include features (e.g., protrusions or depressions) on a surface of the lens or inclusions in the bulk lens material.

In general, the nature of the optical elements can be selected based on a variety of design parameters to provide a desired degree of contrast reduction on the user's retina. Generally, these design parameters include the optical element density, their size and shape, and their refractive index, for example, and are discussed in more detail below. Ideally, the optical elements are selected to provide high visual acuity on the fovea and reduced image contrast on other parts of the retina with sufficiently low discomfort to the wearer to allow for extended, continuous wear. For instance, it can be desirable for children to be comfortable wearing the eyeglasses for most, if not all, of a day. Alternatively, or additionally, optical elements can be designed for specific tasks, especially tasks which are believed to strongly promote eyelength growth, e.g., video gaming, reading or other wide angle, high contrast image exposure. For example, in such situations (e.g., where the user experiences high contrast in their peripheral vision and/or situations that do not require the wearer to move and to orient themselves using peripheral vision), the scattering intensity and scatter angle in the periphery can be increased, while considerations of consciousness and self-esteem may be less of a concern. This can lead to a higher efficiency in peripheral contrast reduction in such high contrast environment. Similarly, the blur radius and intensity of defocusing lenslets or optical aberration features can be tailored.

It is believed that reduced image contrast on the fovea of the user's eye is less efficient at controlling eye growth than reducing image contrast on other parts of the user's retina. Accordingly, the scattering centers can be tailored to reduce (e.g., minimize) light scattered into the user's fovea, while relatively more of the light on other parts of the retina is scattered light. The amount of scattered light on the fovea can be affected by the size of the clear apertures, but also by the nature of the scattering centers, especially those closest to the clear apertures. In some examples, for example, the scattering centers closest to the clear apertures can be designed for less efficient light scattering than those further away. Alternatively, or additionally, in some examples scattering centers closest to the clear apertures can be designed for smaller angle forward scattering that those further from the aperture. In a similar fashion, the amount of blur generated by defocusing lenslets or optical aberration features is dependent on density of the features, their size and intensity of visual blurring, e.g., by the amount of relative plus add-power of lenslets). Design optimization to reduce blurring in central vision while inducing blur in the peripheral retinal region enables a comfortable visual experience, while reducing the progression of myopia.

In certain examples, scattering centers can be designed to deliver reduced narrow angle scattering and increased wide angle scattering through geometry of scattering centers to create even light distribution on retina/low contrast signal, while preserving visual acuity. For example, the scattering centers can be designed to generate significant wide forward angle scattering (e.g., such as more than 10%, 20% or more, 30% or more, 40% or more, 50% or more, deflected by more than 2.5 deg.). Narrow angle forward scattering, i.e., within 2.5 deg., can be kept relatively low (e.g., 50% or less, 40% or less, 30% or less, 20% or less, 10% or less).

In general, a variety of different metrics can be used to evaluate the performance of scattering centers in order to optimize them for use in myopia reducing eyeglasses. For example, scattering centers can be optimized empirically, e.g., based on physical measurements of lenses with different scattering centers shapes, sizes, and layouts. For example, light scattering can be characterized based on haze measurements, such as international test standards for haze (e.g., ASTM D1003 and BS EN ISO 13468). Conventional hazemeters can be used, e.g., a BYK-Gardner haze meter (such as the Haze-Gard Plus instrument) that measures how much light is totally transmitted through a lens, the amount of light transmitted undisturbed (e.g., within 0.5 deg.), how much is deflected more than 2.5 deg., and clarity (amount within 2.5 deg.), which can be considered a measure for narrow angle scattering. Other equipment can also be used to characterize light scattering for purposes of empirically optimizing scattering patterns. For example, equipment that measures light diffusion by measuring light in annular ring around 2.5 deg. can be used (e.g., equipment from Hornell described in standard EN 167).

Alternatively, or additionally, contrast reducing optical elements can be optimized by computer modelling software (e.g., Zemax or Code V).

In some examples, scattering centers can be designed based on optimization of a point spread function, which is a representation of an image of the scattering center on the retina. For example, the size, shape, composition, spacing and/or refractive index of the scattering centers can be varied to evenly spread illumination of retina such that the retina outside of fovea is homogeneously blanketed with scattered light to reduce (e.g., minimize) contrast at this region of the retina.

In some examples, the optimization of light scattering blanketing the peripheral retina accentuates the intensity of scattered light vs. undisturbed light in certain areas of the retina to more strongly suppress high contrast images. High contrast images, e.g., reading black and white text, tend to stem more from the lower half of the visual orbit. Therefore, a stronger blanketing of the upper retinal orbit with scattered light can be beneficial to reduce the signal for axial length growth, while reducing the visual impact, e.g., glare or halos, on the upper visual orbit. Similarly, blur from defocusing lenslets or optical aberration features can be modified in intensity to influence lower and upper part of the visual orbit differently.

Alternatively, or additionally, scattering centers can be designed based on optimization of a modulation transfer function, which refers to the spatial frequency response of the human visual system. For instance, the size, shape, and spacing of the scattering centers can be varied to smoothen attenuation of a range of spatial frequencies. Design parameters of the scattering centers can be varied in order to increase or decrease certain spatial frequencies as desired. Generally, the spatial frequencies of interest for vision are 18cycles per deg. on the fine side, and 1.5 cycles per deg. on the course side. Scattering centers can be designed to provide increased signal at certain subsets of spatial frequencies within this range.

The aforementioned metrics can be used to evaluate scattering centers based on the size and/or shape of the scattering centers, both of which can be varied as desired. For example, the scattering centers can be substantially round (e.g., spherical), elongate (e.g., ellipsoidal), or irregularly shaped. Generally, where scattering centers are protuberances on a surface of the lens, the protuberances should have a dimension (e.g., diameter) that is sufficient large to scatter visible light, yet sufficiently small so as not to be resolved by the wearer during normal use. For example, the scattering centers can have a dimension in a range from about 0.001 mm or more (e.g., about 0.005 mm or more, about 0.01 mm or more, about 0.015 mm or more, about 0.02 mm or more, about 0.025 mm or more, about 0.03 mm or more, about 0.035 mm or more, about 0.04 mm or more, about 0.045 mm or more, about 0.05 mm or more, about 0.055 mm or more, about 0.06 mm or more, about 0.07 mm or more, about 0.08 mm or more, about 0.09 mm or more, about 0.1 mm) to about 1 mm or less (e.g., about 0.9 mm or less, about 0.8 mm or less, about 0.7 mm or less, about 0.6 mm or less, about 0.5 mm or less, about 0.4 mm or less, about 0.3 mm or less, about 0.2 mm or less, about 0.1 mm).

Note that for smaller scattering centers, e.g., having a dimension that is comparable to the wavelength of light (e.g., 0.001 mm to about 0.05 mm), the light scattering may be considered Raleigh or Mie scattering. For larger scattering centers, e.g., about 0.1 mm or more, light scattering may be mostly due to geometric scattering. Optical elements may also include, for example, non-focusing lenslets, prisms, or higher-order aberration lenslets.

In general, the dimension of the optical elements may be the same across each lens or may vary. For example, the dimension may increase or decrease as a function of the location of the optical element, e.g., as measured from the clear aperture and/or as a function of distance from an edge of the lens. In some examples, the optical element dimensions vary monotonically as the distance from the center of the lens increases (e.g., monotonically increase or monotonically decrease). In some cases, monotonic increase/decrease in dimension includes varying the diameter of the optical element linearly as a function of the distance from the center of the lens.

The shape of optical elements can be selected to provide an appropriate light scattering or blur profile. For example, the optical elements can be substantially spherical or aspherical. In some examples, optical elements can be elongated in one direction (e.g., in the horizontal or vertical direction), such as in the case of elliptical scattering centers. In some examples, the optical elements are irregular in shape.

Generally, the distribution of optical elements in patterned area 530 can vary to provide an appropriate level of light scattering or blur. In some examples, the optical elements are arranged in a regular array, e.g., on a square grid, spaced apart by a uniform amount in each direction. In general, the optical elements are spaced so that, collectively, they provide sufficient contrast reduction in the viewer's periphery for myopia reduction. Typically, smaller spacing between scattering centers will result in greater contrast reduction (provided adjacent scattering centers do not overlap or merge). In general, scattering centers can be spaced from their nearest neighbor by an amount in a range from about 0.05 mm (e.g., about 0.1 mm or more, about 0.15 mm or more, about 0.2 mm or more, about 0.25 mm or more, about 0.3 mm or more, about 0.35 mm or more, about 0.4 mm or more, about 0.45 mm or more, about 0.5 mm or more, about 0.55 mm or more, about 0.6 mm or more, about 0.65 mm or more, about 0.7 mm or more, about 0.75 mm or more) to about 2 mm (e.g., about 1.9 mm or less, about 1.8 mm or less, about 1.7 mm or less, about 1.6 mm or less, about 1.5 mm or less, about 1.4 mm or less, about 1.3 mm or less, about 1.2 mm or less, about 1.1 mm or less, about 1 mm or less, about 0.9 mm or less, about 0.8 mm or less). As an example, spacing can be 0.55 mm, 0.365 mm, or 0.240 mm.

Optical elements may be arrayed in grids that are not square. For example, hexagonal (e.g., hexagonally close packed) grids may be used. Non-regular arrays are also possible, e.g., random or semi-random placement may be used. Displacement from square grids or hexagonally packed grids is also possible, e.g., by a randomized amount.

In general, the coverage of a lens by optical elements can vary depending on the pattern. Here, coverage refers to the proportion of the lens's total area, as projected onto the plane shown in FIG. 4 that corresponds to an optical element. Typically, a lower optical element coverage will yield lower scattering or blur than higher coverage (assuming individual optical elements are discrete, i.e., they do not merge to form larger optical elements). Scattering center coverage can vary from 5% or more to about 75%. For example, coverage can be 10% or more, 15% or more, 20% or more, 25% or more, 30% or more, 35% of more, 40% or more, 45% or more, such as 50% or 55%). Coverage can be selected according to a comfort level of a user, e.g., to provide a level of peripheral vision sufficiently comfortable that the wearer will voluntarily wear the eyeglasses for extended periods (e.g., all day) and/or according to the desired intensity with which the axial eye length growth signal is suppressed.

It is believed that light from a scene that is incident on the lens in scattering area 530 between the optical elements contributes to a recognizable image of the scene on the user's retina, while light from the scene incident on the optical elements does not necessarily. Moreover, at least some of the light incident on the optical elements is transmitted to the retina, so has the effect of reducing image contrast without substantially reducing light intensity at the retina. Accordingly, it is believed that the amount of contrast reduction in the user's peripheral field of view is correlated to (e.g., is approximately proportional to) the proportion of the surface area of the reduced-contrast areas covered by the optical elements.

In general, the scattering centers are intended to reduce the contrast of images of objects in the wearer's peripheral vision without significantly degrading the viewer's visual acuity in this region. For example, the scattering centers can scatter predominantly into wide angles. Here, peripheral vision refers to the field of vision outside of the field of the clear aperture. Image contrast in these regions can be reduced by 40% or more (e.g., 45% or more, 50% or more, 60% or more, 70% or, more, 80% or more) relative to an image contrast viewed using the clear aperture of the lens as determined using methods discussed below. Contrast reduction can be measured by contrast sensitivity loss of one or more letters, or one or more lines, on a high contrast or low contrast visual acuity eye chart, such as a Snellen chart or ETDRS eye chart. Contrast reduction could be one letter or more, 2 letters or more, 3 letters or more, 4 letters or more, or 5 letters or more, or could be one line or more, two lines or more, or three lines or more. Contrast reduction could also be less than a certain amount, such as three lines or less, two lines or less, one line or less; or five letters or less, 4 letters or less, 3 letters or less, 2 letters or less, or one letter; all as measured on a high contrast or low contrast visual acuity eye chart. Contrast reduction may be set according to the needs of each individual case. It is believed that a typical contrast reduction would be in a range from about 50% to 55%. Contrast reductions of lower than 50% may be used for very mild cases, while subjects who are more predisposed might need a higher than 55% contrast reduction. Visual acuity can be corrected to 20/30 or better (e.g., 20/25 or better, 20/20 or better) as determined by subjective refraction, while still achieving meaningful contrast reduction. In examples, contrast reduction can result in loss of two or fewer Snellen chart lines (e.g., 1.5 or fewer lines, one line or less), where one line of loss corresponds to a visual acuity drop from 20/20to 20/25.

Contrast, here, refers to the difference in luminance between two objects within the same field of view. Accordingly, contrast reduction refers to a change in this difference.

Contrast and contrast reduction may be measured in a variety of ways. In some examples, contrast can be measured based on a brightness difference between different portions of a standard pattern, such as a checkerboard of black and white squares, obtained through the clear aperture and scattering center pattern of the lens under controlled conditions.

Alternatively, or additionally, contrast reduction may be determined based on the optical transfer function (OTF) of the lens (see, e.g., http://www.montana.edu/jshaw/documents/18%20EELE582_S15_OTFMTF.pdf). For an OTF, contrast is specified for transmission of stimuli in which light and dark regions are sinusoidally modulated at different “spatial frequencies.” These stimuli look like alternating light and dark bars with the spacing between bars varying over a range. For all optical systems the transmission of contrast is lowest for the sinusoidally varying stimuli having the highest spatial frequencies. The relationship describing the transmission of contrast for all spatial frequencies is the OTF. The OTF can be obtained by taking the Fourier transform of the point spread function. The point spread function can be obtained by imaging a point source of light through the lens on to a detector array and determining how light from a point is distributed across the detector.

In the event of conflicting measurements, the OTF technique is preferred. In some examples, contrast may be estimated based on the ratio of the area of the lens covered by scattering centers compared to the area of the clear apertures. In this approximation, it is assumed that all the light that hits the scattering centers becomes uniformly dispersed across the entire retinal area, which reduce the amount of light available in lighter areas of an image and this adds light to darker areas. Accordingly, contrast reduction may be calculated based on light transmission measurements made through the clear apertures and scattering area of a lens.

Patterned area 530 has a circular shape, although other shapes are also possible (e.g., elliptical, polygonal, or other shape, such as irregular shapes including images). The size of patterned area is typically selected so that reduced contrast of the user's peripheral vision is experienced over a substantial part of the user's visual field, even when not looking directly through the on-axis aperture. Patterned area 530 can have a diameter (or maximum dimension, for non-circular areas) of 30 mm or more (e.g., 40 mm or more, 50 mm or more, 60 mm or more, 70 mm or more, 80 mm or more e.g., 100 mm or less, 90 mm or less, 80 mm or less, 70 mm or less, 60 mm or less). In some examples, the patterned area extends to the edge of the lens.

In some examples the periphery of the patterned area can be blended with the clear area by gradually reducing the optical element amount, density or power.

In some examples the clear area can exhibit a lower amount of light scattering or blur compared to the patterned area.

Referring to FIG. 5, eyeglasses 501 include two lenses 500a and 500b in eyeglass frames 550. Each lens corresponds to lens 500 shown in FIG. 4, shaped and sized to fit frames 550 with the second clear aperture 520 aligned below clear aperture 510 along the axis 132, an angle a from the vertical axis. In each case, the offset angle a is in the direction of the user's nose. While this angle is the same in lenses 500a and 500b, in some examples, the offset angle can be different. For example, different offset angles can be used to accommodate variations between the vergence for each eye.

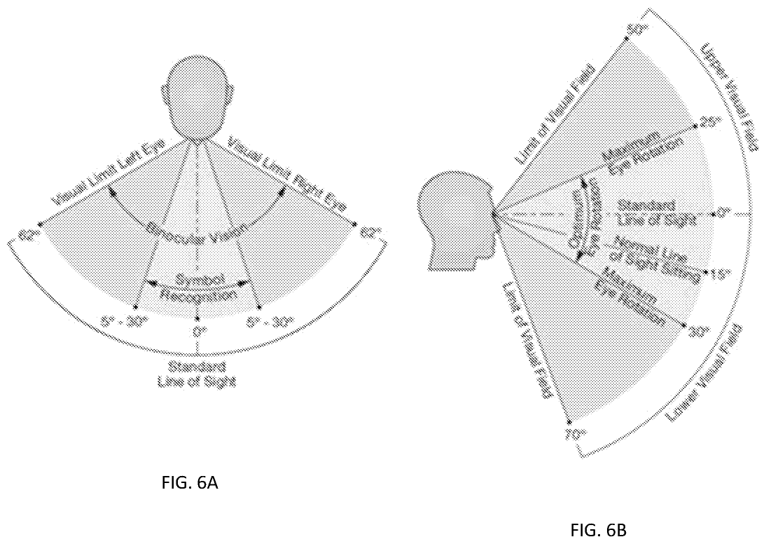

Referring to FIGS. 6A and 6B, clear apertures 510 and 520 can be sized, shaped, and positioned in eyeglasses 501 to provide a line of sight through aperture 510 along the Standard Line of Sight of a user (e.g., for distance vision) and to provide a line of sight through aperture 520 along the Normal Line of Sight Sitting (e.g., for near vision, such as for reading). Clear aperture 510 can be sized and positioned to provide a line of sight through the clear aperture for ±2° or more (e.g., ±3° or more, ±4° or more, ±5° or more, such as ±10° or less, ±9° or less, ±8° or less, ±7° or less, ±6° or less) in the vertical and/or horizontal directions. The angular range in the horizontal and vertical directions can be the same or different. The angular range in the upper visual field can be the same or different as the angular range in the lower visual field.

Clear aperture 520 can be sized and positioned to provide a line of sight through the clear aperture for ±2° or more (e.g., ±3° or more, ±4° or more, ±5° or more, such as ±10° or less, ±9° or less, ±8° or less, ±7° or less, ±6° or less) in the vertical and/or horizontal directions about the Normal Line of Sight Sitting axis. The angular range in the horizontal and vertical directions can be the same or different. In some examples, clear aperture 520 can have a horizontal width sufficient so that the user has a line of sight through the aperture in the Symbol Recognition region, e.g., at 15° below the Standard Line of Sight. For example, the horizontal width of clear aperture 120 can be sized to provide a line of sight through the clear aperture for up to ±30° (e.g., up to ±25°, up to ±20°, up to ±15°, up to ±12°).

While ophthalmic lens 500 features a circular distance vision aperture and a circular near vision aperture, more generally, one or both of these apertures can have non-circular shapes, e.g., to provide desired field of view side along the Standard Line of Sight axis and the Normal Line of Sight Sitting axis. For example, either or both clear apertures can be elliptical, polygonal, or have irregular shapes.

As noted, the horizontal and vertical axes refer to how lens 500 is ultimately oriented in a pair of eyeglass frames. In an unmounted spectacle lens 500 prior to shaping the edge for mounting in a frame, where the lens is plano or spherical, such lenses are typically radially symmetric and the angle a is arbitrary until the lens is shaped for mounting. However, in lenses which do not possess radial symmetry, such as cylindrical powered or toric lenses, the angle a can alternatively be defined relative to the orientation of the second aperture 520 compared to the cylinder axis of the cylindrical component. In other words, in addition to aligning the aperture 510 to the appropriate point on the lens (e.g., the center of the lens), it is important to align the axis 532 relative to the cylinder axis of the lens.

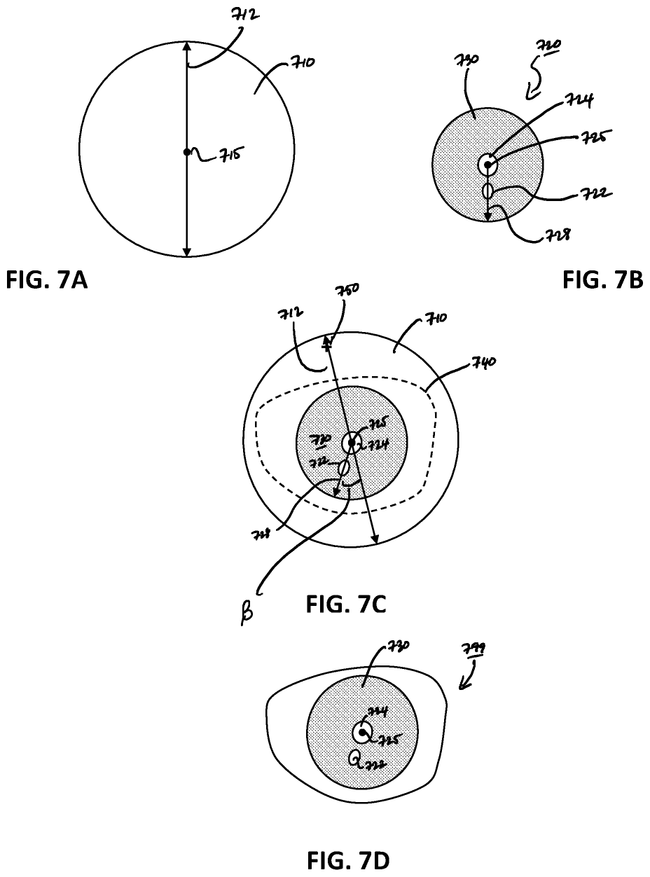

This process is illustrated in FIGS. 7A-7D. Here, FIG. 7A shows a lens 710 having non-zero cylinder with cylinder axis 712. The geometric center 715 of lens 710 is also shown. FIG. 7B shows a pattern 720 of scattering centers. Pattern 720 includes a pair of apertures 722 and 724 arranged in an area 730 of scattering centers. An axis 728 running from the geometric center 725 of the pattern, which is also the geometric center of aperture 724, through the geometric center of aperture 722 is also shown.

FIG. 7C shows the relative alignment of pattern 720 with lens 710. In this example, the center 725 of pattern 720 is aligned with center 715 of lens 710. In addition to that, the pattern is aligned with axis 728 at an angle β with cylinder axis 712. The angle β can be specified, for example, based on the cyl axis of the user's prescription and the range of motion of their pupil from distance vision to near vision. FIG. 7C also shows the outline of the edge 740 of the lens once sized for a pair of eyeglass frames. A marker 750 is provided near the lens periphery, marking the cylinder axis providing a fiducial for aligning the lens and the pattern and for shaping the lens to its final form 799, shown in FIG. 7D. Marker 750 can be a printed or etched fiducial used to establish the orientation of the lens relative to the lens modification system before, during, or after forming pattern 720 on the lens and can be any optical feature identifiable by the alignment system used in conjunction with the lens modification system. The marker can be formed using the same system used for form pattern 720 or using a different system. In some embodiments, marker 750 is formed within the lens, in the bulk lens material.

While the foregoing example utilizes printed or etched fiducials, which are examples of optical features, to establish the orientation of the cylinder axis of the lens in order to form the pattern with the desired orientation, other features can be used for this purpose. For example, it is possible to measure the optical properties of the lens itself, i.e., to measure the cylinder axis and then use that measurement to properly align the pattern to the lens. Alternatively, or additionally, in some embodiments a physical feature can be used to establish the proper alignment of the lens.

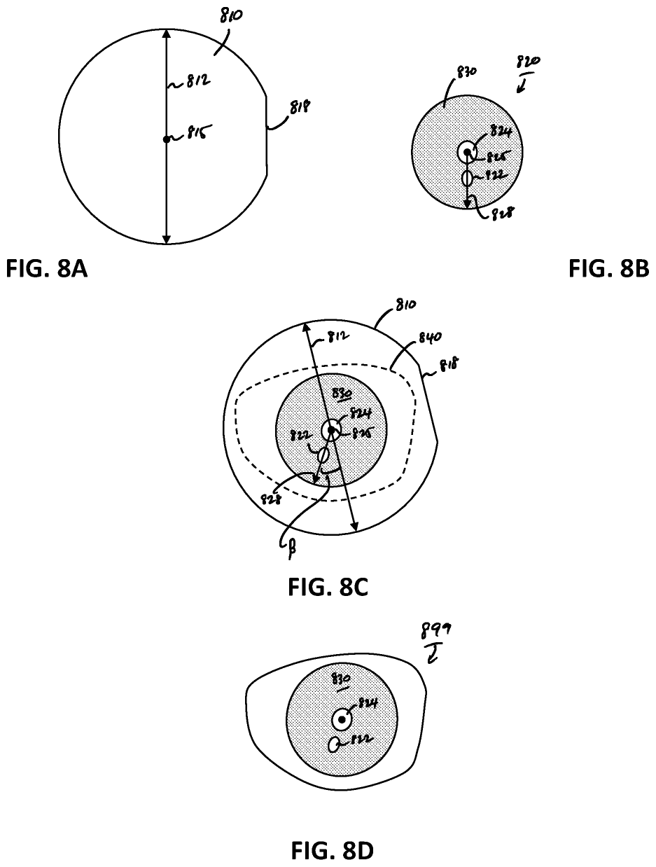

For example, referring to FIG. 8A, a lens 810 has non-zero cylinder with cylinder axis 812 and a straight-edged section 818 in the otherwise circular edge of the lens. The straight-edged section 818 is aligned parallel to axis 812. The geometric center 815 of lens 810 is also shown. Here, the geometric center of the lens refers to the center of the circle defined by the edge of lens 810.

FIG. 8B shows a pattern 820 of scattering centers for forming on lens 810. Pattern 820 includes a pair of apertures 822 and 824 arranged in an area 830 of scattering centers. An axis 828 running from the geometric center 825 of the pattern, which is also the geometric center of aperture 824, through the geometric center of aperture 822 is also shown.

FIG. 8C shows the relative alignment of pattern 820 with lens 810. In particular, the center 825 of pattern 820 is aligned with center 815 of lens 810. In addition to that, the pattern is aligned with axis 828 at an angle β with cylinder axis 812. FIG. 8C also shows the outline of the edge 740 of the lens once sized for a pair of eyeglass frames. Straight-edged section 818 is used to establish the vertical and horizontal directions for shaping the lens to its final form 899, shown in FIG. 8D.

Other types of physical features can be used for alignment purposes alternatively, or in addition to, edge 818. For example, in some embodiments, one or more notches can be made in the edge having a known relationship (e.g., aligned with or offset from by a known amount) with axis 812. The physical features can be formed on the lens before, during, or after forming the pattern on the lens.

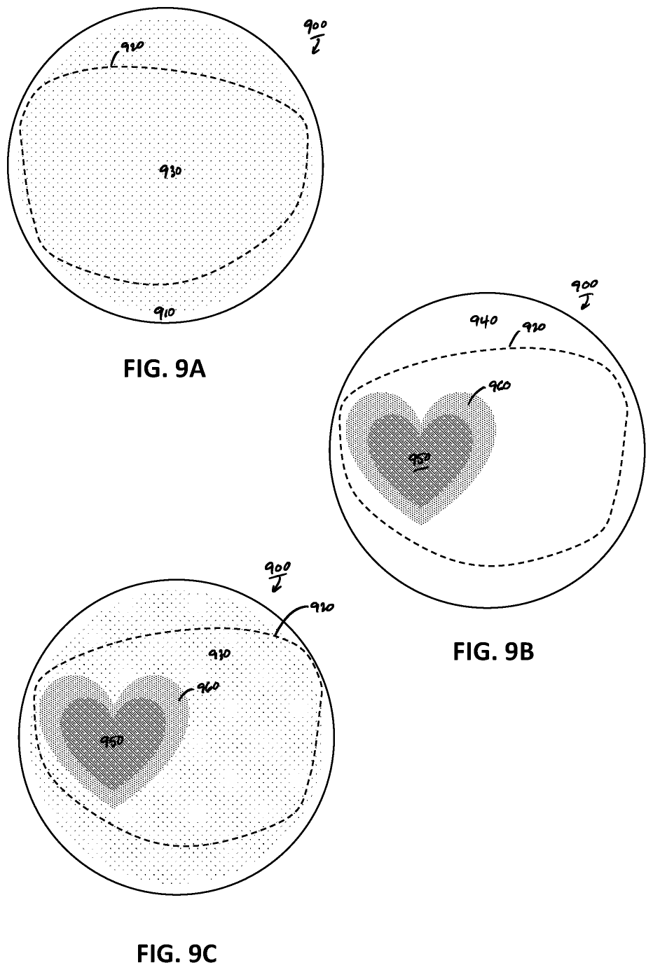

In the examples above, the pattern of optical elements occupies a geometric shape, such as a circle, and features optical elements arranged in a regular arrangement such as in an annular pattern, on a grid, or series of stripes, or in a random manner. However, as noted previously, irregular patterns or patterns having non-circular outlines (e.g., irregular outlines) can be used. Such patterns may be a recognizable shape or image. An example is shown in FIG. 9A. Here, a pattern 930 of optical elements in a circular area is formed on one side 910, e.g., the side facing the wearer, of a lens 900. An outline 920 of the lens shaped for eyeglass frames is shown.

On the opposite surface, a recognizable shape or images can be formed, such as an image, artwork, logo, and the like. The size or density of the pattern of optical elements can be varied so that parts of the pattern appear lighter or darker in reflection to an observer. The size or density of the optical patterns can be varied to create a grayscale image. If colored material is used for depositing or creating the optical elements, the size, density, and color of the optical patterns can be varied to create a color image. Similar to other rotationally asymmetric patterns, these patterns may have a specified orientation when mounted in eyeglass frames, or have a specified orientation on the eye when used as a contact lens. For example, as shown in FIG. 9B, side 940 of lens 900 features a heart-shaped pattern with an inner area of one density of optical elements and an outer area with a different density.

The resulting lens 900, shown in FIG. 9C, features optical elements on both side. The patterns on the front surface (i.e., facing away from the wearer during use) can be formed so that these shapes are visible to a person looking at the wearer without being perceptible to the wearer themselves.

The irregular shaped patterns shown in FIGS. 9A-9C are merely examples and more generally the techniques disclosed herein can be used to form patterns yielding much more complex imagery. In general, by varying the outline of the pattern, and the density and size of the optical elements, it is possible to provide eyeglasses that display almost any imagery that can be digitized. Accordingly, the disclosed techniques allow a user to customize their lenses to have names, signatures, logos, images of pets, family members, friends, pop culture figures and so on.

Moreover, by forming patterns on both sides the imagery can change depending on the relative location of the observer with respect to the lens due to the parallax effect of the two displaced images on the front side and the back side of the lens.

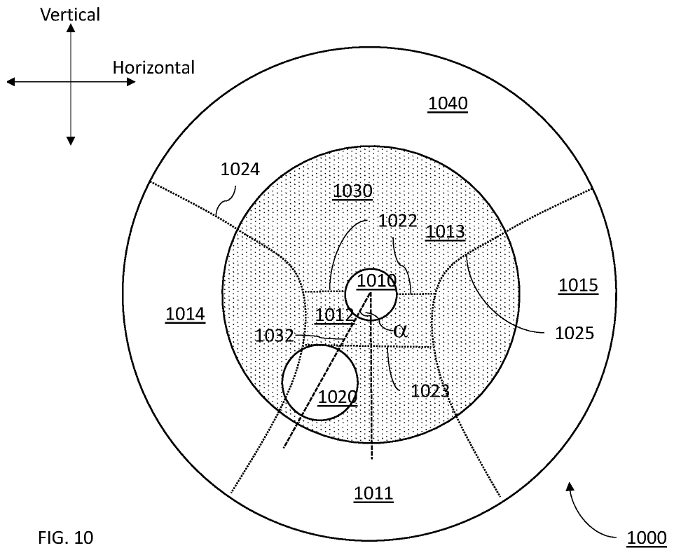

The foregoing examples feature single vision lenses, such as plano, sphere, and toric lenses. More generally, multifocal lenses—such as progressive lenses or bifocal lenses—can also be used. Progressive lenses are radially asymmetric and typically characterized by a gradient of increasing lens power, added to the wearer's correction for the other refractive errors. The gradient starts at the wearer's distance prescription at the top of the lens and reaches a maximum addition power, or the full reading addition, lower in the lens to match the natural path of the eye as it focuses on near objects. The length of the progressive power gradient on the lens surface generally depends on the design of the lens, with a final addition power usually between 0.75 and 3.50 diopters. An example of a progressive lens with a rotationally asymmetric pattern is shown in FIG. 10.

As illustrated, lens 1000 includes five different zones, separated by dotted lines 1022, 1023, 1024, and 1025 in the figure. These include a near-viewing zone 1011, an intermediate zone 1012, a distance-viewing zone 1013. Such a lens may also include peripheral distortion zones 1014 and 1015. Although demarcated by dotted lines, the variation in optical power from one zone to the next is typically gradual.

With respect to the scattering/clear properties of the lens, progressive ophthalmic lens 1000 includes a clear outer region 1040, a light scattering area 1030, and a first clear aperture 1010 for distance vision and a second clear aperture 1020 for near vision. Second clear aperture 1020 is aligned along an axis 1032 that is offset by an angle, a, from the vertical axis of the lens. Distance vision clear aperture 1010 overlaps (in this case, partially) with distance-viewing zone 1013 of the progressive lens, while near vision aperture 1020 overlaps with near-viewing zone 1011.

In some embodiments when a multifocal lens is used, the second clear aperture (e.g., aperture 1020 in lens 1000 is aligned specifically on an area of the lens having add power for near vision. For example, the location of the second aperture can have an optical power of +0.25 D (e.g., +0.5 D or more, +0.75 D or more, +1.0 D or more, +1.25 D or more, +1.5 D or more, +1.75 D or more, +2.0 D or more) or more compared to the optical power of the lens at the first clear aperture (i.e., the aperture for distance vision).

As noted previously, other optical elements than scattering centers can be used as alternative, or in addition to, scattering centers. For example, a lens can include one or more lenslets having an optical power different from the base lens in the areas identified as “scattering areas” in the embodiments described above. More generally, the scattering area is also referred to as the patterned area. Examples of such lenslets are disclosed, for example, in U.S. Pat. No. 10,268,050 entitled “Spectacle Lens” issued on Apr. 23, 2019, in PCT Publication WO 2019/166653, entitled “Lens Element” published on Sep. 6, 2019, in PCT Publication WO 2019/166653, entitled “Lens Element” published on Sep. 6, 2019, PCT Publication WO 2019/166654, entitled “Lens Element” published on Sep. 6, 2019, PCT Publication WO 2019/166655, entitled “Lens Element” published on Sep. 6, 2019, PCT Publication WO 2019/166657, entitled “Lens Element” published on Sep. 6, 2019, PCT Publication WO 2019/166659, entitled “Lens Element” published on Sep. 6, 2019, and PCT Publication WO 2019/206569, entitled “Lens Element” published on Oct. 31, 2019. For example, lenslets for myopic defocus can be used. In some examples, the optical elements are annular refractive structures (e.g., Fresnel lenses) for myopic defocus, examples of which are shown in U.S. Pat. No. 7,506,983 entitled “Method of Optical Treatment” issued on Mar. 24, 2009. Prismatic elements can also be used.

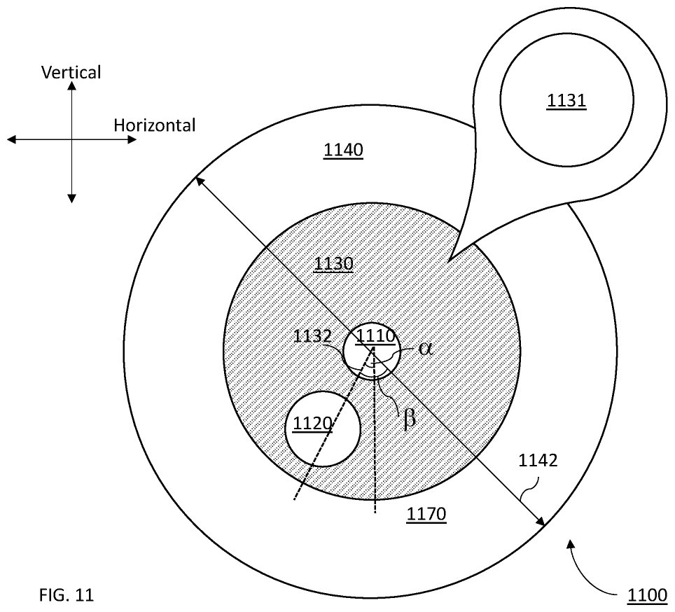

An example of a rotationally asymmetric lens with a rotationally asymmetric pattern of lenslets is shown in FIG. 11. Here, a lens 1100 has a non-zero cylinder and a cylinder axis 1142. The pattern of optical elements includes a first clear aperture 1110 and an annular shaped area 1130 surrounding the clear aperture that features an array of lenslets 1131 (shown in inset) sized and shaped for myopic defocus. The lenslets introduce defocus to portions of a wavefront that would otherwise be focused onto the user's retina. First clear aperture 1110 is positioned substantially near the center of lens 1100. Myopic defocus area 1130 is also centered with respect to the lens center. Myopic defocus area 1130 is also surrounded by a clear area 1140. A second clear aperture 1120 is also provided in light scattering area 1130, separated from clear aperture 1110 along an axis 1132 that is offset by an angle a from the vertical axis of the lens. Cyl axis 1142 is aligned at an angle β with respect to axis 1132.

Generally, the optical properties of lenslets can vary depending on the degree of defocus considered appropriate for a user. For example, the lenslets can be spherical or aspherical or contain higher order aberrations. The lenslets can have positive or negative optical power. In some embodiments, the optical power of the lenslets is zero (e.g., wherein the base power of the lens is strongly negative). The lenslets have each have the same optical power or different lenslets can have differing optical power. In some embodiments, lenslets can have an add power of +0.25 D or more (e.g., +0.5 D or more, +0.75 D or more, +1.0 D or more, +1.25 D or more, +1.5 D or more, +1.75 D or more, +2.0 D or more, +3.0 D or more, +4.0 D or more; such as up to +5.0 D) compared to the base optical power of the lens. In certain embodiments, lenslets can have an add power of −0.25 D or less (e.g., −0.5 D or less, −0.75 D or less, −1.0 D or less, −1.25 D or less, −1.5 D or less) compared to the base optical power of the lens.

The size of the lenslets can also vary as appropriate. The lenslets can have a diameter of 0.5 mm or more (e.g., 0.8 mm or more, 1 mm or more, 1.5 mm or more, 2 mm or more, 3 mm or more; such as up to 5 mm).

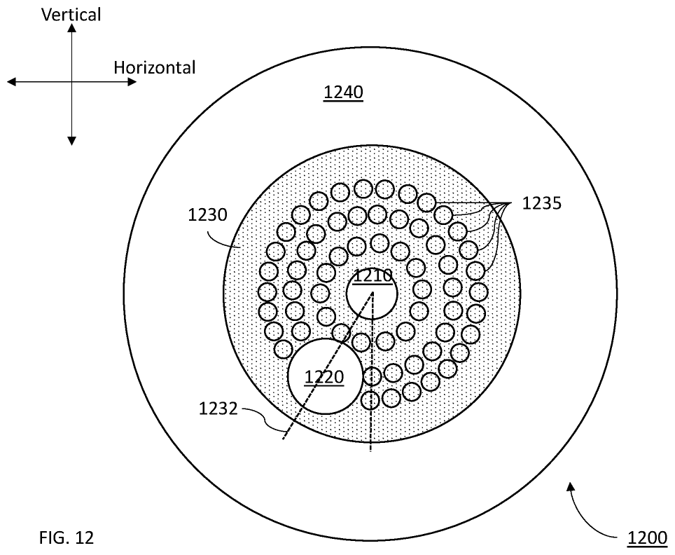

Some embodiments can include both lenslets and scattering centers. For example, referring to FIG. 12, an example lens 1200 includes a clear outer region 1240, a light scattering area 1230, a first clear aperture 1210 for distance vision and a second clear aperture 1220 for near vision. Second clear aperture 1220 is aligned along an axis 1232 that is offset by an angle, α, from the vertical axis of the lens.

Scattering area 1230 includes scattering centers as described above. In addition, scattering area 1235 includes lenslets 1235 arranged in rings around aperture 1210. The lenslets introduce defocus to portions of a wavefront that would otherwise be focused onto the user's retina. Scattering centers are included at the locations of lenslets 1235. For example, scattering centers can be formed on a surface of each lenslet 1235, on the opposite lens surface but overlapping with the same lateral positions as lenslets 1235, and/or included within the bulk of lens 1200 overlapping laterally with lenslets 1235. In some embodiments, scattering centers are included between lenslets 1235, but do not laterally overlap with the lenslets. In certain embodiments, the scattering area of the lens includes only lenslets, but not additional scattering centers.

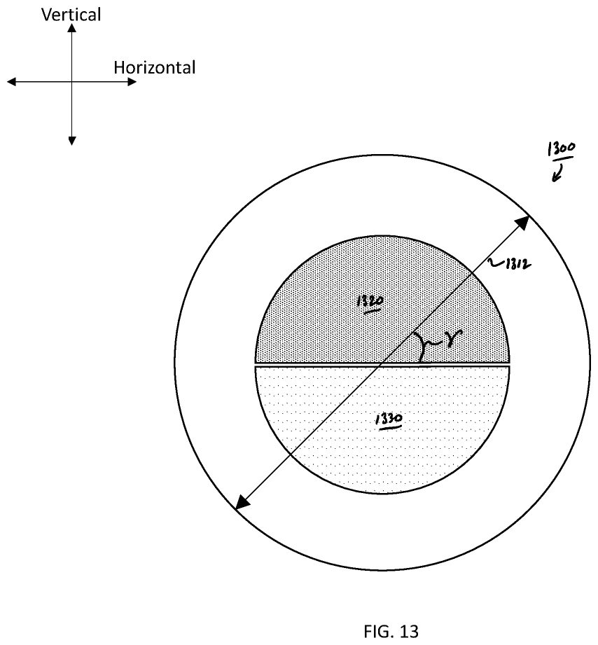

A further example of a rotationally asymmetric lens with a rotationally asymmetric pattern is shown in FIG. 13, in which a lens 1300 having a cylinder axis 1312 at an angle y with respect to the horizontal direction. Lens 1300 includes a pattern of optical elements composed of two discrete zones: a top zone 1320 and a bottom zone 1330, each composing half the patterned area. The different zones 1320 and 1330 have different arrangements of optical elements. For example, depending on the implementation, the zones can have the same type of optical elements (e.g., scattering centers) but different densities. For instance, top zone 1330 can have a lower density of scattering centers than bottom zone 1320, providing increased scattering of light for light transmitted through the bottom zone. Alternatively, in certain embodiments, one zone can include lenslets and the other can feature scattering centers.

Other variations are also possible. For instance, more than two zones can be used and, in some embodiments, multiple zones can be used with one or more apertures.

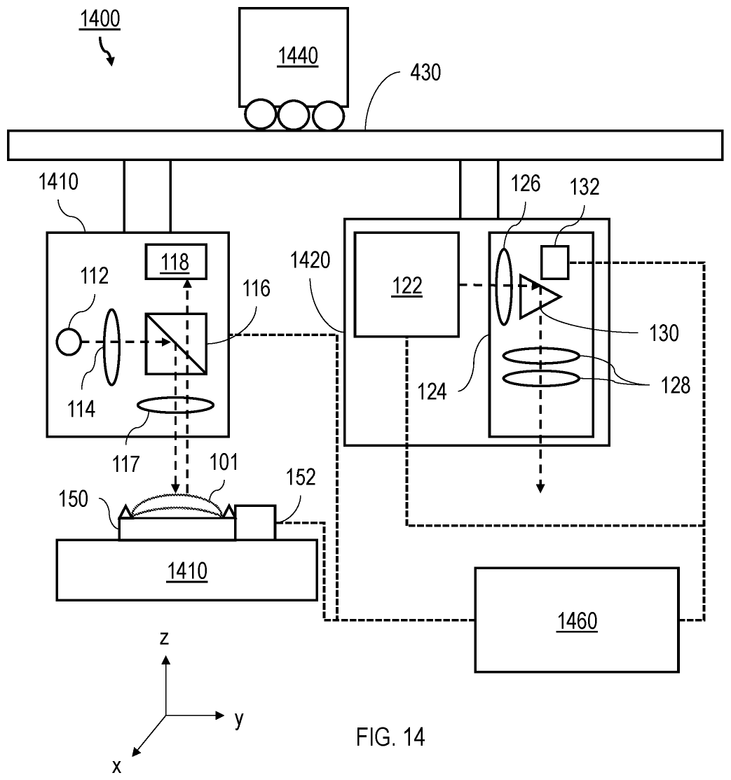

While the system depicted in FIG. 1 features a conveyor that moves a stage with a lens between a measurement subsystem and a laser exposure subsystem, other implementations are possible. For example, in certain cases, the stage may remain at a single location and the system sequentially positions the measurement subsystem and laser exposure subsystem relative to the stage. Referring to FIG. 14, an example automated alignment and exposure system 1400 for forming patterns of optical elements on stock ophthalmic lens 101 includes a measurement subsystem 1410, a laser exposure subsystem 1420, both attached to a rigid frame 1430), and an actuator that moves the two subsystems back and forth over a stationary platform 1410, supporting stage 150 and lens 101. Operation of the subsystems and actuator is controlled by an electronic controller 1460. A Cartesian coordinate system is provided for ease of reference.

The conveyor includes a conveyor belt 140 with rollers 142 and stages 150 positioned on the conveyor belt 140 that each support a corresponding lens 101 and position the lens 101 with respect to the measurement subsystem 110 and laser exposure subsystem 120. The conveyor belt 140 moves the stages 150 in the y-direction, advancing the stage first beneath the measurement subsystem 110 and then to the laser exposure subsystem 120. Each stage includes an actuator 152 that moves the corresponding stage 150 in the x-direction, orthogonal to the direction of travel of the conveyor belt 140.

Measurement subsystem 1410 and laser exposure subsystem can be the same as the measurement subsystems and laser exposure subsystems described previously.

In some cases, both the stage and the measurement and/or laser subsystems can move relative to a fixed reference frame of the system (e.g., defined by a supporting frame). In some cases, certain components in either or both subsystems can remain stationary while others are moved relative to the lens. For example, the laser beam of the laser exposure subsystem can be stationary, but an optical subsystem (e.g., composed of one or more mirrors) can be moved back and forth over the lens in order to expose the lens to the laser light and make room for the measurement subsystem during the measurement step.

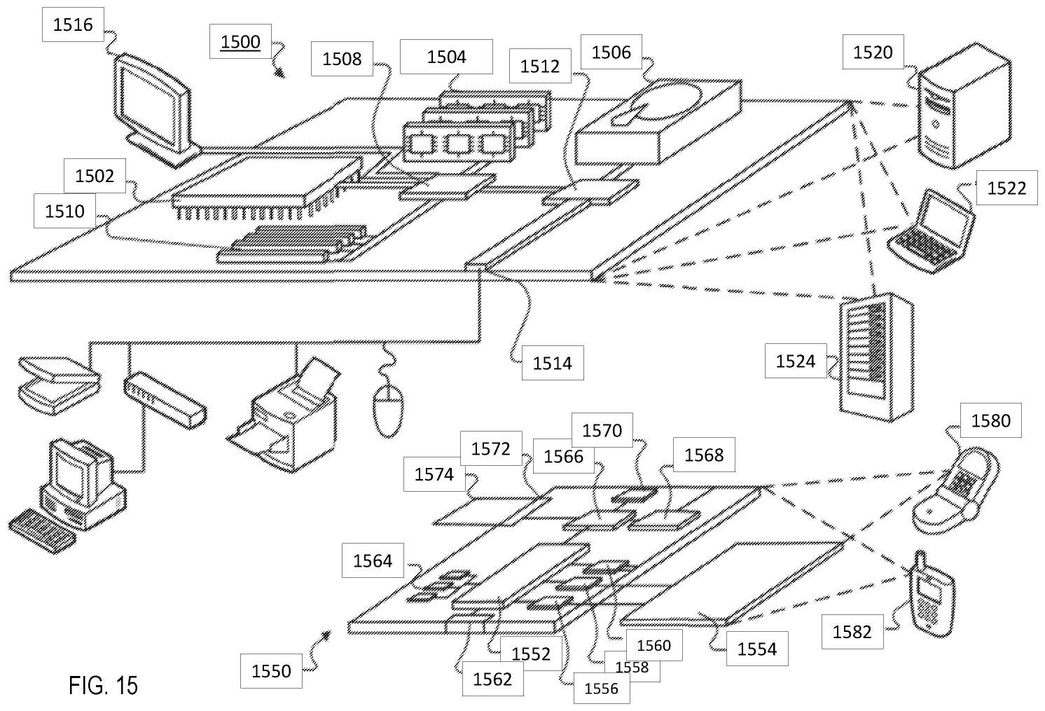

As noted previously, the systems and methods disclosed above utilize an electronic controller to implement aspects of the manufacturing systems and methods described. FIG. 15 shows an example of a computing device 1500 and a mobile computing device 1550 that can be used as an electronic controller to implement the techniques described here. The computing device 1500 is intended to represent various forms of digital computers, such as laptops, desktops, workstations, personal digital assistants, servers, blade servers, mainframes, and other appropriate computers. The mobile computing device 1550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1500 includes a processor 1502, a memory 1504, a storage device 1506, a high-speed interface 1508 connecting to the memory 1504 and multiple high-speed expansion ports 1510, and a low-speed interface 1512 connecting to a low-speed expansion port 1514 and the storage device 1506. Each of the processor 1502, the memory 1504, the storage device 1506, the high-speed interface 1508, the high-speed expansion ports 1510, and the low-speed interface 1512, are interconnected using various busses, and may be mounted on a common motherboard or in other manners as appropriate. The processor 1502 can process instructions for execution within the computing device 1500, including instructions stored in the memory 1504 or on the storage device 1506 to display graphical information for a GUI on an external input/output device, such as a display 1516 coupled to the high-speed interface 1508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1504 stores information within the computing device 1500. In some implementations, the memory 1504 is a volatile memory unit or units. In some implementations, the memory 1504 is a non-volatile memory unit or units. The memory 1504 may also be another form of computer-readable medium, such as a magnetic or optical disk.

The storage device 1506 is capable of providing mass storage for the computing device 1500. In some implementations, the storage device 1506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1502), perform one or more methods, such as those described above. The instructions can also be stored by one or more storage devices such as computer- or machine-readable mediums (for example, the memory 1504, the storage device 1506, or memory on the processor 1502).

The high-speed interface 1508 manages bandwidth-intensive operations for the computing device 1500, while the low-speed interface 1512 manages lower bandwidth-intensive operations. Such allocation of functions is an example only. In some implementations, the high-speed interface 1508 is coupled to the memory 1504, the display 1516 (e.g., through a graphics processor or accelerator), and to the high-speed expansion ports 1510, which may accept various expansion cards (not shown). In the implementation, the low-speed interface 1512 is coupled to the storage device 1506 and the low-speed expansion port 1514. The low-speed expansion port 1514, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1500 may be implemented in a number of different forms, as shown in the figure. For example, it may be implemented as a standard server 1520, or multiple times in a group of such servers. In addition, it may be implemented in a personal computer such as a laptop computer 1522. It may also be implemented as part of a rack server system 1524. Alternatively, components from the computing device 1500 may be combined with other components in a mobile device (not shown), such as a mobile computing device 1550. Each of such devices may contain one or more of the computing device 1500 and the mobile computing device 1550, and an entire system may be made up of multiple computing devices communicating with each other.

The mobile computing device 1550 includes a processor 1552, a memory 1564, an input/output device such as a display 1554, a communication interface 1566, and a transceiver 1568, among other components. The mobile computing device 1550 may also be provided with a storage device, such as a micro-drive or other device, to provide additional storage. Each of the processor 1552, the memory 1564, the display 1554, the communication interface 1566, and the transceiver 1568, are interconnected using various buses, and several of the components may be mounted on a common motherboard or in other manners as appropriate.

The processor 1552 can execute instructions within the mobile computing device 1550, including instructions stored in the memory 1564. The processor 1552 may be implemented as a chipset of chips that include separate and multiple analog and digital processors. The processor 1552 may provide, for example, for coordination of the other components of the mobile computing device 1550, such as control of user interfaces, applications run by the mobile computing device 1550, and wireless communication by the mobile computing device 1550.

The processor 1552 may communicate with a user through a control interface 1558 and a display interface 1556 coupled to the display 1554. The display 1554 may be, for example, a TFT (Thin-Film-Transistor Liquid Crystal Display) display or an OLED (Organic Light Emitting Diode) display, or other appropriate display technology. The display interface 1556 may comprise appropriate circuitry for driving the display 1554 to present graphical and other information to a user. The control interface 1558 may receive commands from a user and convert them for submission to the processor 1552. In addition, an external interface 1562 may provide communication with the processor 1552, so as to enable near area communication of the mobile computing device 1550 with other devices. The external interface 1562 may provide, for example, for wired communication in some implementations, or for wireless communication in other implementations, and multiple interfaces may also be used.

The memory 1564 stores information within the mobile computing device 1550. The memory 1564 can be implemented as one or more of a computer-readable medium or media, a volatile memory unit or units, or a non-volatile memory unit or units. An expansion memory 1574 may also be provided and connected to the mobile computing device 1550 through an expansion interface 1572, which may include, for example, a SIMM (Single In Line Memory Module) card interface. The expansion memory 1574 may provide extra storage space for the mobile computing device 1550, or may also store applications or other information for the mobile computing device 1550. Specifically, the expansion memory 1574 may include instructions to carry out or supplement the processes described above, and may include secure information also. Thus, for example, the expansion memory 1574 may be provide as a security module for the mobile computing device 1550, and may be programmed with instructions that permit secure use of the mobile computing device 1550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. The instructions, when executed by one or more processing devices (for example, processor 1552), perform one or more methods, such as those described above. The instructions can also be stored by one or more storage devices, such as one or more computer- or machine-readable mediums (for example, the memory 1564, the expansion memory 1574, or memory on the processor 1552). In some implementations, the instructions can be received in a propagated signal, for example, over the transceiver 768 or the external interface 1562.

The mobile computing device 1550) may communicate wirelessly through the communication interface 1566, which may include digital signal processing circuitry where necessary. The communication interface 1566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1568 using a radio-frequency. In addition, short-range communication may occur, such as using a Bluetooth, WiFi, or other such transceiver (not shown). In addition, a GPS (Global Positioning System) receiver module 1570 may provide additional navigation- and location-related wireless data to the mobile computing device 1550, which may be used as appropriate by applications running on the mobile computing device 1550.

The mobile computing device 1550 may also communicate audibly using an audio codec 1560, which may receive spoken information from a user and convert it to usable digital information. The audio codec 1560 may likewise generate audible sound for a user, such as through a speaker, e.g., in a handset of the mobile computing device 1550. Such sound may include sound from voice telephone calls, may include recorded sound (e.g., voice messages, music files, etc.) and may also include sound generated by applications operating on the mobile computing device 1550.

The mobile computing device 1550 may be implemented in a number of different forms, as shown in the figure. For example, it may be implemented as a cellular telephone 1580. It may also be implemented as part of a smart-phone 1582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a key board and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some examples, the computing system can be cloud based and/or centrally calculating the pattern. In such case anonymous input and output data can be stored for further analysis. In a cloud based and/or calculation center set-up, compared to distributed calculation of the patterns, it is easier to ensure data quality, and accomplish maintenance and updates to the calculation engine, compliance to data privacy regulations and troubleshooting.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems.

Furthermore, while the system shown in FIG. 1 uses a measurement subsystem that measures light reflected from a lens, in some implementations measurements systems that operate in transmission can be used. For instance, the light source and detector of the subsystem can be positioned on opposite sides of the lens. In some cases, one of these components can be housed in the stage 150. Alternatively, one of these components can be located on the opposite side of the stage 150 from the other. In such instances, at least a portion of the stage and conveyor belt should be transparent to the wavelength of light used by the measurement subsystem.

A number of embodiments have been described, other embodiments are in the following claims.

1. A method for forming a pattern of optical features on a surface of an ophthalmic lens having a lens axis, comprising:
receiving the ophthalmic lens on a stage;
positioning the ophthalmic lens relative to a first apparatus by causing relative motion between the first apparatus and the stage;
measuring light transmitted or reflected by the ophthalmic lens or a surface property of the ophthalmic lens using the first apparatus;
determining a position of the lens axis based on the measured light or surface property;
obtaining information about an alignment of the pattern of optical features relative to the lens axis;
aligning the ophthalmic lens with a laser system based on the position of the lens axis; and
exposing locations of the ophthalmic lens to a laser beam from the laser system to form the pattern of optical features on the ophthalmic lens according to the information about the alignment.

2. The method of claim 1, wherein the first apparatus is a light sensing apparatus and the position of the lens axis is determined based on the measured light.

3. The method of claim 1, wherein the first apparatus is a surface profiler and the position of the lens axis is determined based on the surface property.

4. The method of claim 1, wherein the laser beam forms the optical features on a surface of the ophthalmic lens and/or the laser beam forms the optical features in a bulk of the ophthalmic lens.

5. (canceled)

6. The method of claim 1, wherein determining the position of the lens comprises determining a position of a lens axis of the lens.

7. The method of claim 6, wherein the position of the lens axis is determined based on an image of the ophthalmic lens obtained from the measured light or from one or more surface profiles of the ophthalmic lens, based on a surface profile of the ophthalmic lens obtained from the measured light, and/or based on a prism measurement of the ophthalmic lens obtained from the measurement light.

8. (canceled)

9. (canceled)

10. The method of claim 1, wherein the lens axis coincides with a geometric center of the ophthalmic lens and/or the lens axis corresponds to an optical axis of the ophthalmic lens.

11. (canceled)

12. (canceled)

13. The method of claim 1, wherein the optical elements are selected from the group consisting of light scattering centers, microlenses, annular Fresnel lens elements, and prismatic elements.

14. The method of claim 1, wherein the optical elements are selected from the group consisting of protrusions on one or both of the surfaces, depressions on one or both of the surfaces, and inclusions in the lens material having a refractive index different from a refractive index of the lens material.

15. The method of claim 1, wherein the ophthalmic lens is a single vision lens or a multifocal lens.

16. The method of claim 1, wherein the ophthalmic lens continuously moves relative to the light sensing apparatus while measuring the light transmitted or reflected by the lens.

17. The method of claim 1, wherein the ophthalmic lens continuously moves relative to the laser system while exposing the locations of the ophthalmic lens.

18. The method of claim 1, further comprising automatically changing a relative position of the ophthalmic lens with respect to the first apparatus and the laser system after measuring the light transmitted or reflected by the ophthalmic lens or measuring the surface property.

19. The method of claim 18, wherein the first apparatus and the laser system are stationary while the ophthalmic lens is moved or the ophthalmic lens is stationary while the first apparatus and the laser system are moved.

20. (canceled)

21. The method of claim 1, wherein the pattern comprises an aperture free of the optical elements.

22. The method of claim 18, wherein the aperture is surrounded by a region containing optical elements and/or the lens axis intersects the aperture.

23. (canceled)

24. The method of claim 18, wherein the aperture has a maximum lateral dimension of 2 mm or more.

25. The method of claim 1, wherein exposing the locations of the ophthalmic lens to the laser beam comprises varying a position of a surface of the ophthalmic lens with respect to a focal plane of the laser system.

26. (canceled)

27. The method of claim 1, further comprising determining an exposure sequence for the laser system for forming the pattern of optical features on the ophthalmic lens based on the information about the alignment.

28. The method of claim 27, wherein determining the exposure sequence comprises geometrically transforming a predetermined pattern based on the information about the alignment to account for the position of the lens axis.
